(19) United States
(12) Patent Application Publication
(10) Pub. No.: US 2026/0339691 A1
(43) Pub. Date: Oct. 29, 2026

(54) MACHINE-LEARNING-BASED SEASONALITY DETECTION AND RESOURCE SCALING

(71) Applicant: CAST AI Group, Inc., Miami, FL (US)

(72) Inventor: Jan Sykora, Prague (CZ)

(21) Appl. No.: 19/296,760

(22) Filed: Aug. 11, 2025

Related U.S. Application Data
(60) Provisional application No. 63/793,987, filed on Apr. 24, 2025.

(51) Int. Cl. G06F 9/455; G06F 9/50

(52) U.S. Cl. CPC G06F 9/45558; G06F 9/505; G06F 2209/5019

(57) ABSTRACT

A system analyzes historical resource usage data to determine whether a workload exhibits seasonality. In response to determination of seasonality, the system determines one or more frequency components characterizing the seasonal patterns. Based on the seasonality determination and identified frequency components, the system selects a prediction approach from multiple available prediction methods. The system generates a compute resource demand forecast using the selected prediction method, producing predicted resource consumption values at future time intervals. From this forecast, the system determines time-based scaling recommendations that specify vertical autoscaling parameters (such as per-container resource request values) and/or horizontal autoscaling parameters (such as replica count targets). These time-based scaling recommendations are provided to a container orchestration system, enabling proactive resource provisioning that anticipates future demand changes rather than reacting to them after they occur.

### CROSS REFERENCE TO RELATED APPLICATIONS

This application claims priority to U.S. Provisional Patent Application Ser. No. 63/793,987, filed on Apr. 24, 2025, which is incorporated herein by reference in its entirety.

### TECHNICAL FIELD

This disclosure relates generally to cloud computing, and more specifically to using machine-learning to provide recommendations on compute resource scaling.

### BACKGROUND

Existing autoscaling techniques typically rely on simplistic heuristics to detect workload seasonality and to determine resource recommendations. One such heuristic involves calculating the ratio of maximum to minimum observed resource usage over a predefined historical window. If this ratio exceeds a fixed threshold, the workload is classified as seasonal. However, such approaches suffer from several inherent limitations.

First, these heuristics are highly sensitive to outliers. A single anomalous spike or dip in usage can distort the ratio and result in incorrect classification of a workload as seasonal or non-seasonal. Second, these methods lack the ability to distinguish between periodic trends and random fluctuations, thereby conflating noise with signal. Third, these techniques are reactive rather than predictive; they may detect the presence of seasonality in retrospect, but do not provide a forward looking model to forecast future resource demands based on such seasonality.

As a result, recommendations for resource allocation based on existing techniques may be misaligned with actual workload behavior, leading to under-provisioning or over-provisioning. This not only degrades application performance but also results in inefficient utilization of computing resources.

### SUMMARY

The embodiments described herein address the above issues by incorporating predictive-modeling techniques that analyze historical resource-usage data to detect seasonality and generate forward-looking compute-resource forecasts that are conditioned on the principal or “driving” components of the observed periodic behavior. By first decomposing the usage signal into its dominant frequency (or other latent) components and then tailoring the forecast to each of those components, the system produces granular, component-aware predictions that more accurately capture the true workload demand profile. This refined forecasting capability, in turn, supports correspondingly precise resource-allocation recommendations—minimizing both over-and under-provisioning by aligning allocations with the specific factors that give rise to the seasonality.

In some embodiments, a system is configured to proactively optimize compute resource allocation for containerized workloads by performing a series of prediction-driven autoscaling operations. The system begins by analyzing historical resource usage data—such as CPU or memory consumption metrics—to determine whether the workload exhibits seasonality. In response to detecting seasonality, the system identifies one or more dominant frequency components that characterize the periodic usage pattern. Based on this seasonality determination and the identified frequency components, the system selects an appropriate prediction method from a plurality of available approaches. For example, it may choose a frequency-based reconstruction technique or a percentile-based statistical forecast. The selected method is then used to generate a compute resource demand forecast that predicts future resource usage at discrete time intervals. Using this forecast, the system formulates a time-based scaling recommendation, which may include vertical autoscaling parameters such as per-container CPU request values, or horizontal autoscaling parameters such as target replica counts. The scaling recommendation is then provided to a container orchestration system—such as Kubernetes—for execution, enabling proactive and workload-aware resource provisioning.

### BRIEF DESCRIPTION OF THE DRAWINGS

FIG. 1 is a block diagram of a system environment in which an automation system may be implemented in accordance with one or more embodiments.

FIG. 2A illustrates an example architecture of an autoscaling prediction module, in accordance with one or more embodiments.

FIG. 2B illustrates an example process flow for generating and utilizing seasonality-based predictions to inform resource scaling recommendations for workloads in a containerized computing environment, in accordance with one or more embodiments.

FIG. 3A illustrates an example time-series plot of a workload CPU usage and a corresponding resource allocation recommendation generated by an existing optimization system, in accordance with one or more embodiments.

FIG. 3B illustrates another example time-series plot of a workload CPU usage and a corresponding resource allocation recommendation generated by the existing optimization system, in accordance with one or more embodiments.

FIGS. 4A-4E illustrate an example workload CPU usage time-series being divided into multiple frequency components, which can then be combined together to predict future workload CPU usage, in accordance with one or more embodiments.

FIG. 5 illustrates another example time series of a workload with strong seasonality, such that the forecasting time series closely resembles the original time series, in accordance with one or more embodiments.

FIG. 6A is a plot depicting percentage under-provisioning differences between existing system and machine-learning-prediction-based system across different percentiles.

FIG. 6B is a plot depicting unit number under-provisioning differences between existing system and machine-learning-prediction-based system across different percentile.

FIG. 6C is a plot depicting percentage sMAPE (symmetric Mean Absolute Percentage Error) differences between existing system and machine-learning-prediction-based system across different percentiles.

FIG. 6D a plot depicting percentage over-provisioning differences between existing system and machine-learning-prediction-based system across different percentiles.

FIG. 6E is a plot depicting unit number over-provisioning differences between existing system and machine-learning-prediction-based system across different percentiles.

FIG. 7A is a plot depicting a workload with intermittent CPU usage with sharp spikes and long idled periods.

FIG. 7B is a plot depicting another highly dynamic workload, where CPU demand remains consistently high with some variations.

FIG. 8 is a table, presenting a quantitative evaluation of forecasting accuracy and resource allocation efficiency of the forecasting system described herein, comparing key performance metrics across at different time periods, in accordance with one or more embodiments.

FIG. 9 illustrates an example time-series visualization of workload resource consumption and predictive forecasting for a containerized application, in accordance with one or more embodiments.

FIG. 10A illustrates a vertical pod autoscaling (VPA) prediction visualization comparing different prediction approaches for resource allocation, in accordance with one or more embodiments.

FIG. 10B illustrates a VPA prediction visualization for the same workload depicted in FIG. 10A, demonstrating the behavior of the Period Aware Normalized prediction approach in accordance with one or more embodiments.

FIG. 10C illustrates a VPA prediction visualization that emphasizes the behavior of the Top Periods Aware Normalized prediction approach, in accordance with one or more embodiments.

FIG. 11 illustrates a prediction visualization for a containerized workload operating under a coordinated vertical and horizontal autoscaling strategy, in accordance with one or more embodiments.

FIG. 12A illustrates a horizontal pod autoscaling (HPA) prediction visualization for a containerized workload operating without vertical autoscaling, in accordance with one or more embodiments.

FIG. 12B illustrates a HPA prediction visualization for a containerized workload operating without vertical autoscaling, using the Workload Optimization HPA Prediction approach, in accordance with one or more embodiments.

FIG. 13 illustrates a prediction visualization for dynamic HPA Parameters, demonstrating the use of forecasted workload demand to dynamically configure replica bounds and target utilization parameters for Kubernetes HPA, in accordance with one or more embodiments.

FIG. 14 is a flowchart of a method for predictive autoscaling in containerized computing environments, in accordance with one or more embodiments.

FIG. 15 is a block diagram of an example computer suitable for use in a networked computing environment in accordance with one or more embodiments.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

Efficient resource scaling within containerized computing environments relies on the accurate prediction of workload resource consumption over time. One of the primary challenges in achieving such efficiency lies in reliably identifying seasonality patterns in historical compute resource usage data. Existing approaches often employ heuristic techniques that classify workloads as seasonal when the ratio of the maximum to minimum observed usage within a time window exceeds a predefined threshold. While computationally simple, these heuristics exhibit multiple deficiencies that undermine their effectiveness.

For example, the reliance on a maximum-to-minimum ratio renders the classification highly susceptible to transient anomalies. Brief spikes or dips in CPU utilization may distort the computed ratio, leading to erroneous seasonality classification. Additionally, the technique fails to provide adequate resolution in the frequency domain, thereby lacking the ability to distinguish between meaningful periodic trends and random noise. Furthermore, this heuristic method lacks any form of predictive modeling capability and, as such, cannot produce forward-looking insights required for proactive resource scaling.

The embodiments described herein address the above-described issues by enabling detection of workload seasonality to inform forward-looking resource scaling decisions. In some embodiments, the Workload Optimization Orchestration Platform (WOOP) shares metric and metadata inputs with a machine-learned model, such as Chronos, which generates predictions based on pretrained behavior.

In other embodiments, the system applies a frequency-domain analysis using Fast Fourier Transform (FFT) to convert time-series CPU usage data into the frequency domain. This allows identification of dominant periodic components and quantification of their contribution to overall usage variance using an energy ratio. Only the top N components within configured frequency bounds are retained. An inverse FFT (IFFT) reconstructs a smoothed version of the usage pattern, which can be extrapolated to predict future demand. In some embodiments, the FFT-based system may include configurable parameters such as sampling interval, historical and look-ahead windows, frequency limits, energy ratio threshold (e.g., 70%), and tolerance for missing data (e.g., 2%).

The predictive outputs generated by the FFT analysis can then be used to generate recommendations that inform autoscaling behavior in different deployment configurations. In some embodiments, vertical pod autoscaling (VPA) is applied independently of horizontal pod autoscaling (HPA). When only VPA is applied, predictions may be normalized per replica and used to adjust the CPU resource requests accordingly. When only HPA is applied, and predictions are used to determine the appropriate number of replicas based on anticipated total usage. In some embodiments, both VPA and HPA are applied. VPA is used to optimize per-replica resource allocations, while HPA is used to adjust the replica count to meet predicted aggregate demand.

The embodiments described herein provide significant benefits to both HPA and VPA mechanisms by enabling proactive, prediction-driven scaling decisions based on detected workload seasonality. For VPA, the system facilitates more accurate adjustment of CPU and memory resource requests per pod, reducing over-provisioning and improving resource-usage efficiency while maintaining application performance. For HPA, the system allows replica count adjustments to be made in anticipation of future demand rather than in reaction to lagging utilization metrics, thereby improving responsiveness to cyclical workload patterns and reducing the risk of under-provisioning during usage spikes. When applied in combination, the system enables intelligent coordination between VPA and HPA, enabling that workloads are scaled vertically when replica limits are reached, and horizontally when per-replica efficiency is exhausted. This harmonized scaling approach reduces unnecessary scaling oscillations and ensure consistent quality of service across a wide range of usage profiles. Further information regarding VPA and HPA can be found in U.S. patent application Ser. No. 18/913,754, filed Oct. 11, 2024, which is hereby incorporated by reference in its entirety.

While the present disclosure describes the use of Fourier Transform (FT), such as Fast Fourier Transform (FFT), and transformer-based machine learning models, such as Chronos, to identify seasonality and extract dominant frequency components from workload usage data, one of ordinary skill in the art will recognize that alternative techniques may also be used to detect seasonality and generate resource usage forecasts. These alternatives include, but are not limited to, wavelet transforms, empirical mode decomposition (EMD), seasonal-trend decomposition using LOESS (STL), autocorrelation and partial autocorrelation analysis (ACF/PACF), seasonal autoregressive integrated moving average (SARIMA) models, and machine learning-based pattern recognition methods such as spectral clustering or sequence-to-sequence models. Any of these techniques may be substituted for, or used in conjunction with, the described FT-based or transformer-based approaches without departing from the scope of the disclosed invention.

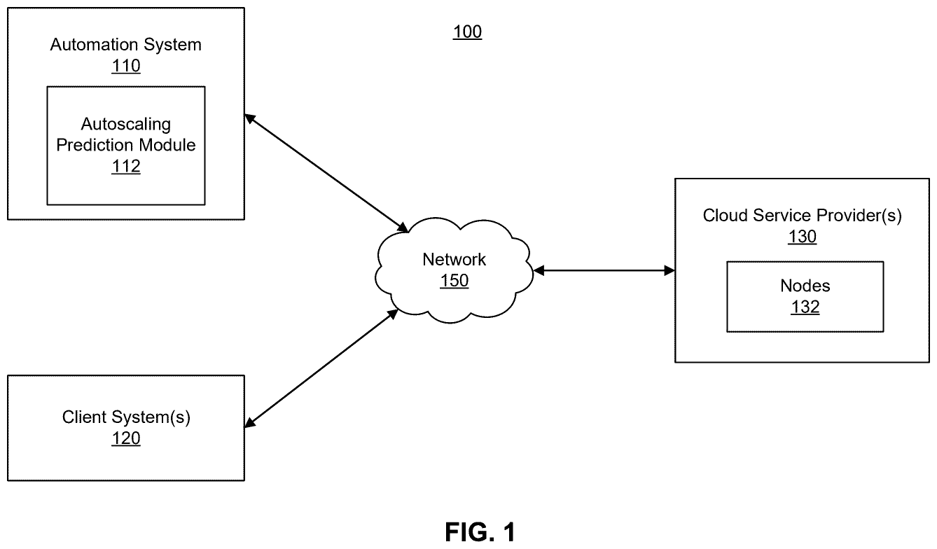

Additional details about the system are further described below with respect to FIGS. 1-14.

### System Architecture

FIG. 1 is a block diagram of a system environment 100 in which an automation system 110 (also referred to “the system”) may be implemented in accordance with one or more embodiments. The environment 100 includes the automation system 110, one or more client devices 120, and one or more cloud service provider(s) 130, all interconnected via a network 150. The cloud service provider(s) 130 host one or more nodes 132, which may be virtual machines (VMs). The cloud service provider(s) 130 may include (but are not limited to) Amazone Web Services (AWS)®, Google Cloud Platform (GCP)®, and/or Microsoft Azure®. The cloud service provider 130 provides computing resources, such as VMs, storage, and networking, over the network 150. VMs are scalable, software-based representations of physical machines that can run operating systems and applications. Networking includes virtualized network components, such as firewalls, and virtual private networks (VPNs). These resources may be made available to users on-demand, enabling flexibility and scalability. In some embodiments, the nodes 132 are part of a Kubernetes cluster, which is a distributed system for managing containerized applications across multiple VMs. Additional details about clusters and Kubernetes services are described in U.S. patent application Ser. No. 17/380,729, filed Jul. 20, 2021 (now issued as U.S. Pat. No. 11,595,306), which is incorporated herein in its entirety.

The automation system 110 includes an autoscaling prediction module 112 configured to generate forward-looking workload resource recommendations by detecting seasonality in historical compute resource usage data. In some embodiments, the autoscaling prediction module 112 interacts and applies pre-trained machine-learning models such as Chronos by sharing relevant metrics and metadata to obtain predicted resource usage. In other embodiments, autoscaling prediction module 112 performs frequency-domain analysis using Fast Fourier Transform (FFT) to extract periodic usage patterns from time-series CPU data. The autoscaling prediction module 112 identifies dominant frequency components, filters out noise, computes an energy ratio to quantify seasonality, and reconstructs a smoothed signal using inverse FFT (IFFT) for extrapolation. In some embodiments, the autoscaling prediction module 112 supports configurable parameters such as sampling interval, analysis window size, frequency bounds, and seasonality thresholds, enabling adaptation to diverse workload profiles.

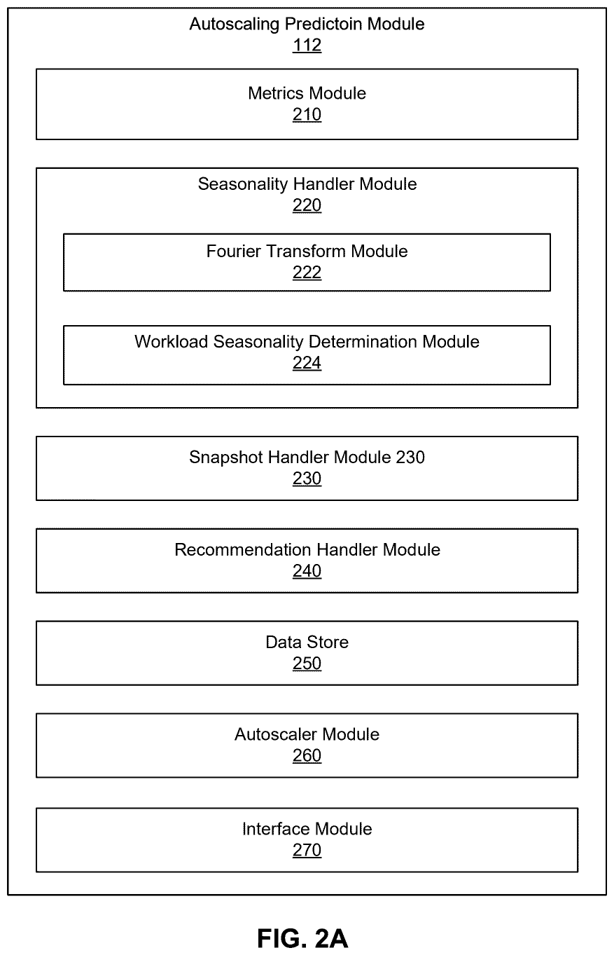

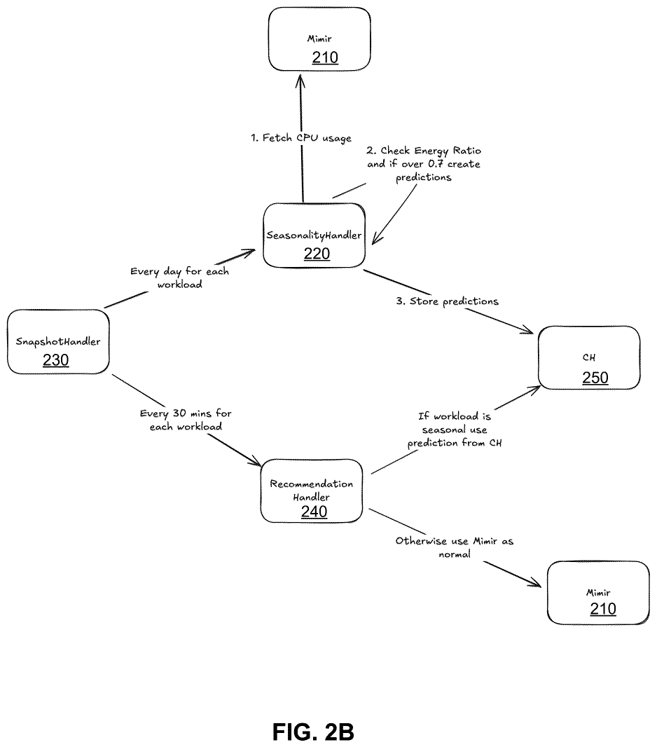

Based on the predictions, the autoscaling prediction module 112 supports several operational modes, including: VPA-only, HPA-only, or combined VPA and HPA. The autoscaling prediction module 112 may provide a variety of scaling recommendations, including next-window maxima, dominant-period aware projections, and multi-period composite predictions, enabling robust, responsive, and resource-efficient autoscaling decisions across containerized environments. Additional details about the autoscaling prediction module 112 are further described below with respect to FIGS. 2-14.

The client device(s) 120 are computing systems associated with various entities. These entities include entities that can provision nodes 132 on the cloud service provider 130, as well as end-users who engage with applications deployed onto the nodes 132. The client devices 120 are also capable of receiving user input as well as transmitting and/or receiving data via the network 150. In one embodiment, a client device 120 is a computer system, such as a desktop or a laptop computer. Alternatively, a client device 120 may be a device having computer functionality, such as a personal digital assistant (PDA), a mobile telephone, a smartphone, or another suitable device. A client device 120 is configured to communicate via the network 150. In one embodiment, a client device 120 executes an application allowing a user of the client device 120 to interact with the automation system 110. For example, the client device 120 may execute a customer mobile application to enable interaction between the client device 120 and the automation system 110 or the cloud service providers 130. As another example, a client device 120 executes a browser application to enable interaction between the client device 120 and the system 110 via the network 150. In another embodiment, a client device 120 interacts with the system 110 through an application programming interface (API) running on a native operating system of the client device 120, such as IOS® or ANDROID™.

The network 150 is configured to facilitate communications among the automation system 110, client device 120, and cloud service provider 130. The network 150 may comprise any combination of local area and/or wide area networks, using both wired and/or wireless communication systems. In one embodiment, the network 150 uses standard communications technologies and/or protocols. For example, the network 150 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 150 may be represented using any suitable format, such as hypertext markup language (HTML) or extensible markup language (XML). In some embodiments, all or some of the communication links of the network 150 may be encrypted using any suitable technique or techniques.

### Example Architecture of the Autoscaling Prediction Module

FIG. 2A illustrates an example architecture of an autoscaling prediction module 112, in accordance with one or more embodiments. The autoscaling prediction module 112 includes a metrics module 210, a seasonality handler module 220, a snapshot handler module 230, a recommendation handler module 240, a data store 250, and an autoscaler module 260. In some embodiments, there may be additional or fewer modules than those illustrated in FIG. 2A. For example, the functionalities of these modules may be redistributed, multiple modules may be combined into a single module. Alternatively, a single module's functionalities may be divided into multiple modules.

The metrics module 210 is configured to collect resource consumption data. In some embodiments, the resource consumption data may be collected via Prometheus queries that monitor Kubernetes workloads. The data may include (but is not limited to) CPU consumption, memory consumption, disk I/O, and/or network bandwidth at container or pod level. In some embodiments, the metrics module 210 aggregates the data and structures the data into time series format. A time series format refers to a data structure that stores data points that are collected or recorded over time at sequential intervals. Each data point in a time series is associated with a specific timestamp, making it ideal for analyzing trends, patterns, and periodic behaviors. In some embodiments, the metrics module 210 generates a data point in the time series periodically, such as every a few seconds, every minute, every a few minutes, etc. For example, each data point may represent a CPU usage percentage during a predetermined time window (e.g., 5 minutes, 10 minutes or 15 minutes). Similarly, different time series may be generated for different resource consumption data points.

The snapshot handler module 230 is configured to process the raw time series data collected by the metrics module 210 and applies a rolling or fixed-time window, e.g., a 15-minute or 10-minute intervals to determine summarized metrics such as maximum CPU usage, average CPU usage, possibility standard deviation or percentile values, among others. For example, for each pod or workload, the snapshot handler module 230 may determine a maximum CPU usage or an average CPU usage of past time window, e.g., last 15 minutes. In some embodiments, the summarized metrics are determined periodically, e.g., every minute, every a few minutes, etc. In some embodiments, the summarized metrics are determined at a frequency lower than the frequency at which data is collected by the metrics module 210. For example, the metrics module 210 collects data every 15 seconds, and the snapshot handler module 230 determines summarized metrics every 10 minutes.

The seasonality handler module 220 is configured to analyze metrics describing activity of workloads or pods to detect seasonality. The seasonality handler module 220 includes a Fourier transform module 222 and a seasonality determination module 224. The Fourier transform module 222 is configured to convert a time series metrics (e.g., a CPU usage pattern over time, over-provisioning percentage over time, or under-provisioning percentage over time) into multiple frequency components. Any periodic signal (e.g., fluctuating resource usage) can be represented as a sum of sine and cosine waves of different frequencies. The Fourier transform module 222 can identify a set of frequencies from any given time series metrics. Notably, for some metrics, there is no seasonality or very weak seasonality, the frequency components may expand in a wide spectrum and power of each frequency components is very low.

Various algorithms may be implemented by the Fourier transform module 222 to perform Fourier transform to convert time series data into frequency components. Such algorithms may include (but are not limited to) discrete Fourier transform (DFT), fast Fourier transform (FFT), Goertzel algorithm, short-time Fourier transform (STFT), fast Hartley transform (FHT), modified discrete cosine transform (MDCT), Stockham Auto-sort FFT, parallel FFT, recursive FFT, quantum Fourier transform (QFT), among others.

The seasonality determination module 224 is configured to analyze the frequency components identified by the Fourier transform module 222 to determine whether the workload exhibits seasonality. Each frequency component corresponds to a power magnitude. In some embodiments, the seasonality determination module 224 sorts the frequency components by amplitude and identifies the frequency components with amplitudes greater than a threshold value as dominant frequency components. Alternatively, a top predetermined number (e.g., top 3) of frequency components are deemed as dominant frequency components. The seasonality determination module 224 also determines whether these identified dominant frequency components are sufficiently strong to indicate seasonality rather than noise. In some embodiments, the seasonality determination module 224 may determine how much of a total signal energy is concentrated in dominant frequency components, which may be represented by Equation (1) below:

$$Energy Ratio = \frac{{\sum }_{A ∈ {S}_{N}} {\vert {A}_{i} \vert}^{2}}{{\sum }_{i = 1}^{M} {\vert {A}_{i} \vert}^{2}} , \qquad Equation ( 1 )$$

Where Ai represents amplitude of frequency component I, and S_{N} represents a set of top N frequencies with the largest amplitude, M represents a total number of all frequency components, i.e., a total power of the time series data.

Based on the amplitude of each frequency component, a power magnitude can be computed for each frequency component based on the following Equation (2):

P=0.5*A² Equation (2),

where A is the amplitude, and P is the power magnitude.

In some embodiments, if the energy ratio of the dominant frequency components exceeds a predetermined threshold (e.g., 50%, 70%, 90%, etc.), the workload is classified as seasonal; otherwise, the workload is considered non-seasonal, meaning no significant seasonality exists.

Notably, some workloads are seasonal, while others are non-seasonal. In response to determining that a workload is seasonal, the recommendation handler module 240 is configured to forecast the workload's future resource consumption. In some embodiments, the dominant frequency components can be used to reconstruct future workload behavior. The recommendation handler module 240 may apply an inverse Fourier transform to generate a predicted time series data that simulates and forecasts the real time series data.

Alternatively, or in addition, a time-series machine-learning model may be used to predict seasonal workload behavior. In some embodiments, the time-series machine-learning model may be Chronos machine learning model. In some embodiments, the model may be trained transformer-based time-series forecasting model for probabilistic time-series forecasting. In some embodiments, the model is a deep neural network trained to predict future data points.

In some embodiments, the model transforms time-series data into sequences of tokens through scaling and quantization, and applies language modeling techniques, such as transformer based architectures, to these token sequences. The transformer based architectures may apply self-attention mechanisms to enable the model to learn long-range dependencies in time series data, similar to how transformers capture contextual meaning in text. This allows the model to model complex temporal dependencies across different time periods. In some embodiments, similar to autoregressive language models that predict a next word in a sentence, the model predicts a next time-step in a sequence based on previously observed values.

In some embodiments, the model is trained to predict a range of possible future values rather than a single deterministic outcome, such as 50^{th} percentile prediction, 90^{th} percentile prediction, 10^{th} percentile prediction, among others. Each workload may be set to be associated with a specific percentile prediction, and the autoscaler module 260 allocates resources for workloads based on their associated percentile predictions.

For example, the 50^{th} percentile forecast represents the median expected value. If the recommendation handler module 240 follows the 50^{th} percentile forecast, it will recommend allocating just enough resources to handle the expected workload, balancing efficiency and performance, but does not account for occasional spikes. For example, for workloads that require a balanced trade-off between cost and performance, the recommendation handler 240 follows the 50 th-percentile forecast. Because this value is the statistical median, half of all measured intervals are expected to fall below it and half above it. Allocating resources to the median therefore minimizes total absolute error across the forecast horizon and avoids systematic bias toward either over- or under-provisioning. When the median predicted CPU demand is 0.65 cores, the handler sets each container's CPU request to 0.65 cores (or scales replicas so the aggregate request equals that figure), ensuring efficient operation while accepting that occasional spikes will be handled by headroom or burstable policies.

As another example, the 90^{th} percentile forecast means that 90% of the time, actual resource usage will be below this value, and only 10% of the time, it will exceed it. This is a conservative approach, ensuring that resources are provisioned to handle occasional surges. For instance, when the workload can tolerate occasional latency spikes, the recommendation handler 240 selects the 90th-percentile value of the forecast as the provisioning target. Because 90% of measured intervals are expected to fall below that value, sizing each container—or adjusting the replica count—keeps the service fully performant in nine out of ten intervals while deliberately trading a 10% risk window for cluster-wide efficiency. For example, if the predicted 90th-percentile CPU demand equals 0.85 cores, the handler sets the per-container CPU request to 0.85 cores (or scales replicas proportionally), thereby aligning resource reservations with the chosen service-level objective.

On the other hand, the 10^{th} percentile forecast means that 90% of the time actual resource usage will be higher than the predicted value, and only 10% of the time, it will be lower. This strategy may be used for non-critical workloads where occasional performance degradation is acceptable to save resources. For example, for non-critical, cost-sensitive batch jobs, the handler can instead use the 10 th-percentile forecast, which is deliberately aggressive: 90% of intervals are expected to exceed this value while only 10% fall below it (statistically the mirror image of the 90 th percentile). By provisioning to the 10 th percentile, the system reserves just enough capacity to keep the workload alive, accepting frequent throttling in exchange for maximum cluster utilization. For instance, if the 10 th-percentile CPU demand is 0.20 cores, the handler assigns 0.20 cores per container; the batch job then bursts above that level only when spare capacity exists, yielding significant resource savings.

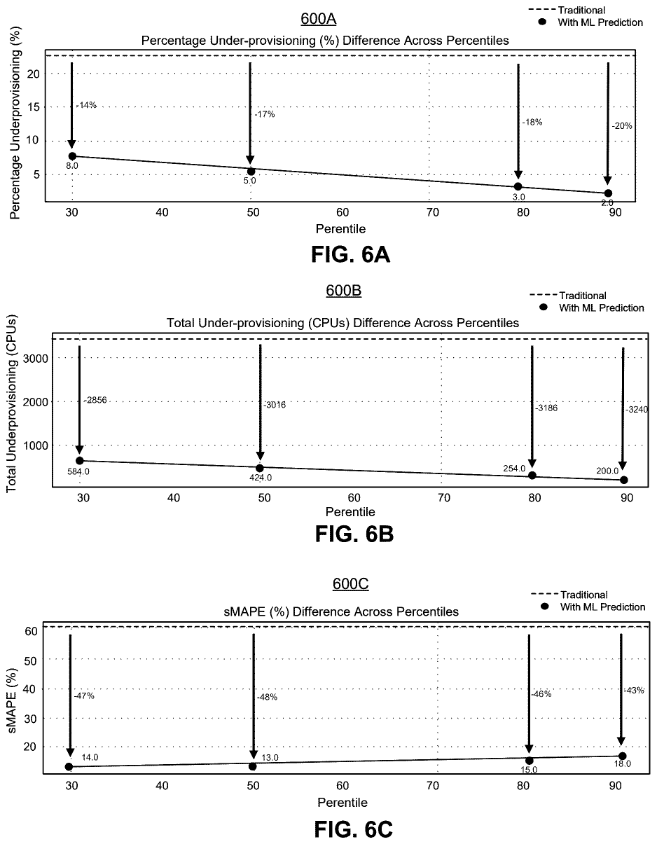

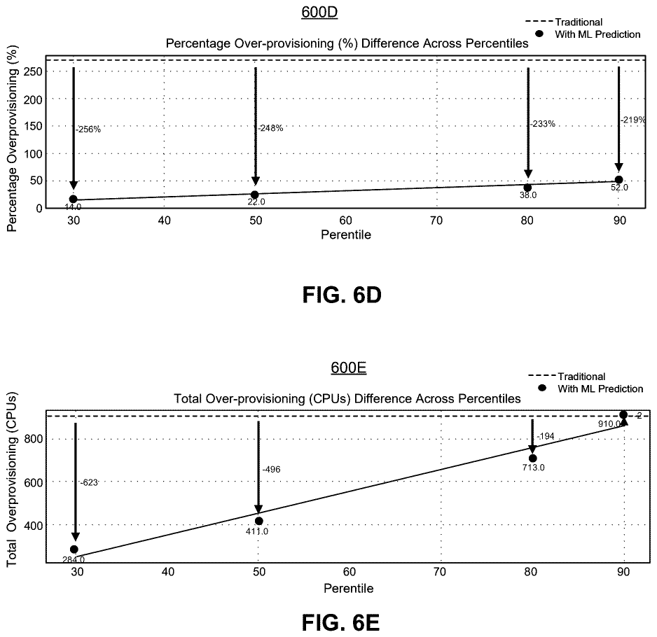

Additional details about application of the machine learning model to forecast different percentiles of resource usage are further described below with respect to FIGS. 6A-6E.

The recommendation handler module 240 is configured to generate resource scaling recommendations based on the determined seasonality or non-seasonality. In some embodiments, the recommendation handler module 240 is configured to generate recommendations for a variety of operational configurations, such as (i) horizontal autoscaling only, (ii) vertical autoscaling only, and (iii) combined horizontal and vertical autoscaling. The recommendation handler module 240 may determine the appropriate scaling policy for each workload based on deployment annotations, autoscaling settings, and detected workload seasonality.

When a workload is configured to use horizontal autoscaling without vertical autoscaling, the recommendation handler module 240 is configured to generate replica count recommendations based on predicted total resource demand. In some embodiments, the recommendation handler module 240 determines a desired number of replica using the following Equation (3):

desiredReplicas=ceil(predictedTotalUsage/(targetUtilization×perReplicaRequest)) Equation (3)

where predictedTotalUsage is derived from the FFT or transformer-based forecast, targetUtilization is a predefined or dynamically predicted target utilization percentage (e.g., 80%), and perReplicaRequest is the fixed resource request per pod. The module ensures that recommended replica counts remain within preconfigured minimum and maximum bounds and may round adjustments to ensure integer scaling granularity. In some embodiments, the recommendation handler module dynamically predicts the min, max, and target utilization values based on workload volatility and forecast uncertainty, allowing the native Kubernetes HPA to make responsive scaling decisions within those bounds.

For workloads operating under vertical autoscaling without horizontal autoscaling, the recommendation handler module 240 determines updated per-pod resource request values (e.g., CPU and memory) while keeping the replica count constant. The recommendation handler module may use seasonality-aware prediction approaches—such as Next Three Normalized, Period Aware Normalized, or Top Periods Aware Normalized—to forecast future resource demand. The predicted total use may be normalized by the current number of replicas to compute per-replica usage, which forms the basis for the vertical autoscaling recommendation. In some embodiments, the recommendation handler module 240 may apply safety buffers, rounding heuristics, and scaling constraints to ensure stability and avoid frequent pod restarts due to small fluctuations.

In some embodiments, the Next Three Normalized prediction approach is used for workloads that do not exhibit significant seasonality, or when the seasonality energy ratio falls below a predetermined threshold. This method applies a fixed-size look-ahead window typically comprising three consecutive forecast points representing a 30-minute future interval. The recommendation handler module 240 identifies the maximum predicted resource usage within this window and normalizes the value by the current number of replicas to derive a per-replica resource recommendation. This conservative and forward-only method ensures sufficient resource provisioning in the immediate term, and is particularly suitable for workloads with stable or bursty but non-cyclic demand patterns. The simplicity of the approach reduces computational overhead and provides baseline robustness when seasonal signal strength is insufficient for higher-order analysis.

In some embodiments, the Period Aware Normalized prediction approach is applied to workloads that exhibit a dominant seasonal component, as determined by the seasonality handler module via Fourier analysis. The recommendation handler module 240 retrieves the dominant frequency component and uses it to define a prediction window and a recommendation interval. In some embodiments, the prediction window may be set as one-half of the dominant period, while the recommendation interval may be set to one-fourth of the dominant period. The module conducts a bidirectional analysis within this window—looking both forward and backward in time—to identify the maximum predicted usage value that characterizes the active phase of the seasonal cycle. The resulting prediction is then normalized by the number of active replicas to generate a VPA-compatible recommendation. This approach enables resource provisioning that is aligned with the workload's cyclic behavior, improving responsiveness at critical cycle transitions while minimizing unnecessary scale adjustments.

In some embodiments, the Top Periods Aware Normalized prediction approach is used for workloads with complex, multi-period seasonal patterns. The recommendation handler module retrieves the top N significant frequency components (e.g., corresponding to 24-hour, 12-hour, and 8-hour periods) and uses the shortest period among these components to determine the prediction cadence. A recommendation interval of one-fourth of the shortest period and a prediction window of one-half of that period may be used to ensure sensitivity to rapid fluctuations. The recommendation handler module 240 may compute cumulative predicted usage by integrating overlapping signals from all dominant components, and performs a composite analysis to determine the maximum predicted resource requirement within the window. This value is then normalized per replica and adjusted for stability. This approach is particularly effective for workloads with overlapping daily and sub-daily cycles, enabling fine-grained and context-aware scaling decisions that account for compound temporal variations.

In some embodiments, when operating in horizontal autoscaling mode, the recommendation handler module 240 may generate replica count recommendations using a dynamic scaling algorithm referred to as the Workload Optimization HPA prediction. Unlike native HPA, which estimates replica counts from predicted total usage and a fixed target utilization, this approach adapts based on observed per-pod behavior. Specifically, the system first calculates the average CPU usage per pod and the corresponding target CPU per pod based on the container's configured resource requests. A scaling factor is then computed using Equation (4) below:

scalingFactor=(avgPodCPUUsage/targetCPUPerPod)−1 Equation (4)

This scaling factor reflects the deviation from the target utilization. The recommendation handler module 240 multiplies this value by the current number of replicas to determine the replica delta as shown in Equation (5) below:

replicaDelta=scalingFactor×currentReplicas Equation (5)

In some embodiments, the recommendation handler module 240 applies the delta in response to the absolute value greater than or equal to one, to prevent frequent adjustments due to minor fluctuations. In some embodiments, the resulting replica count is rounded to the nearest integer. This adaptive mechanism enables fine-grained, load-sensitive scaling in response to real-time or predicted pod-level efficiency metrics.

In some embodiments, the recommendation handler module 240 also enforces minimum and maximum bounds on the number of pod replicas to ensure that scaling actions remain within acceptable operational limits. The minimum replica bound defines the least number of pods that must remain active, even during periods of low resource demand, and may be set to maintain baseline availability, avoid cold starts, or satisfy fault-tolerance requirements. Conversely, the maximum replica bound limits the total number of pods that can be provisioned for a given workload, preventing runaway scaling that could exhaust cluster capacity or cause contention for shared resources. These bounds may be specified by deployment annotations, autoscaler configuration files, or inferred dynamically based on historical usage patterns and service-level objectives. All scaling recommendations—whether driven by predicted demand, observed utilization, or composite heuristics—are clamped within these bounds before being issued to the orchestration system, thereby providing guardrails against both over-scaling and under-scaling behavior.

In some embodiments, the quality of the recommendations may be evaluated to determine whether the recommendations matched actual demand, across a workload's execution time. The recommendation handler module 240 may calculate one or more evaluation metrics, such as under-provisioning percentage, over-provisioning percentage, symmetric mean absolute percentage error (sMAPE), root mean square error (RMSE), or mean absolute error (MAE), to quantify the alignment between predicted and actual resource usage. Additional details about each of these metrics are further described below with respect to Equations (6)-(12).

For a given workload, under-provisioning occurs when an actual usage of resources exceeds a recommended resource allocation. An under-provisioning threshold can be represented by the following Equation (6):

$$underprovisioning = \frac{n}{N} {\sum }_{i = 1}^{N} max ( {usage}_{i} - {recommendation}_{i} , 0 ) \qquad ( Equation 6 )$$

where usageᵢ represents an actual usage of resource, recommendation represents a corresponding recommended resource allocation, n represents a number of pods in a workload, and N represents a total number of time points at which resource consumption and recommendations are measured.

The above equation provides raw values, which do not account for workload scale. The recommendation handler module 240 may further normalize the raw value: the above metric is divided by the total actual usage, represented by the following Equation (7):

$$underprovisioning percentage = 100 \times \frac{{\sum }_{i = 1}^{N} max ( {usage}_{i} - {recommendation}_{i} , 0 )}{{\sum }_{i = 1}^{N} {usage}_{i}} \qquad Equation ( 7 )$$

If usage_i>recommendation_i, the under-provisioning is counted. If usage_i<=recommendation_i, no under-provisioning is counted.

Over-provisioning occurs when a recommended resource allocation exceeds actual usage. An over-provisioning threshold can be measured by the following Equation (8):

$$overprovisioning = \frac{n}{N} {\sum }_{i = 1}^{N} max ( {recommendation}_{i} - {usage}_{i} , 0 ) \qquad Equation ( 8 )$$

where usage represents an actual usage of resource, recommendation represents a corresponding recommended resource allocation, n represents a number of pods in a workload, N represents a total number of time points at which resource consumption and recommendations are measured.

Similarly, the above metric is divided by the total usage to compute an under-provisioning percentage, represented by the following Equation (9):

$$overprovisioning percentage = 100 \times \frac{{\sum }_{i = 1}^{N} max ( {usage}_{i} - {recommendation}_{i} , 0 )}{{\sum }_{i = 1}^{N} {usage}_{i}} \qquad Equation ( 9 )$$

If the system is consistently under-provisioned, i.e., the under-provisioning percentage is greater than a threshold, the workload may suffer from performance issues, slowdowns, or failures. If the system is consistently over-provisioned, i.e., the over-provisioning percentage is greater than a threshold, resources are idled, leading to inefficiencies.

In some embodiments, in addition to under-provisioning and over-provisioning thresholds, the metrics module 210 may also determine other metrics, such as sMAPE (symmetric mean absolute percentage error), RMSE (root mean square error), and MAE (mean absolute error), to evaluate the accuracy of the recommendation handler module 240's forecast about resource usages, e.g., CPU usages.

In some embodiments, sMAPE may be determined based on the following Equation (10):

$$sMAPE = \frac{1}{N} {\sum }_{i = 1}^{N} \frac{\vert {F}_{i} - {A}_{i} \vert}{( \vert {F}_{i} \vert + \vert {A}_{i} \vert ) / 2} \times 100 , \qquad Equation ( 10 )$$

where Fi represents forecasted resource usage (e.g., predicted CPU usage), Ai represents actual resource usage (actual CPU usage), and N represents a total number of observations.

sMAPE measures the percentage error in forecasts. A lower sMAPE indicates better forecasting accuracy. In some embodiments, sMAPE may be calculated for different percentile-based forecasts (e.g., 50^{th} percentile, 80^{th} percentile predictions).

In some embodiments, RMSE may be determined based on the following equation (11):

$$RMSE = \sqrt{\frac{1}{N} {\sum }_{i = 1}^{N} {( {F}_{i} - {A}_{i} )}^{2}} , \qquad Equation ( 11 )$$

where Fi represents forecasted resource usage (e.g., predicted CPU usage), Ai represents actual resource usage (actual CPU usage), and N represents a total number of observations.

RMSE measures the average squared error in predictions. It penalizes larger errors more heavily than MAE. A lower RMSE indicates better accuracy. RMSE helps identify high-variance errors.

In some embodiments, MAE may be determined based on the following Equation (12):

$$MAE = \frac{1}{N} {\sum }_{i = 1}^{N} \vert {F}_{i} - {A}_{i} \vert , \qquad Equation ( 12 )$$

where Fi represents forecasted resource usage (e.g., predicted CPU usage), Ai represents actual resource usage (actual CPU usage), and N represents a total number of observations.

MAE measures an average absolute difference between forecasted and actual values. Unlike RSME, it does not heavily penalize large deviations. A lower MAE indicates better overall prediction accuracy. MAE may be used alongside RMSE to determine if errors are systematically high or low.

These metrics may then be incorporated into a feedback loop that adjusts future recommendation cycles. For example, in response to detecting persistent under-provisioning above a predefined threshold, the recommendation handler module 240 may increase the forecasting percentile (e.g., from 50th to 80th or 90th percentile) to favor more conservative predictions. Alternatively, in response to excessive over-provisioning, the recommendation handler module 240 may lower the percentile or select a less aggressive prediction method.

In some embodiments, the recommendation handler module 240 may automatically switch between different recommendation strategies-such as transitioning from Top Periods Aware Normalized to Period Aware Normalized or Next Three Normalized-based on recent forecast accuracy or seasonality degradation. Additionally, the recommendation handler module 240 may dynamically reconfigure HPA parameters, such as adjusting the target utilization or widening the min-max replica bounds to better absorb forecast variance. When sustained prediction mismatches are observed, the system may also trigger a refresh of the seasonality analysis using updated time-series data, or initiate retraining of the underlying machine learning models. This closed-loop feedback architecture ensures that autoscaling recommendations remain robust, adaptive, and aligned with the evolving behavior of workload resource consumption patterns.

The autoscaler module 260 is configured to execute the scaling decisions generated by the recommendation handler module 240. It acts as an operational interface between prediction-driven recommendations and the actual resource orchestration layer within the containerized computing environment. In some embodiments, the autoscaler module 260 supports horizontal autoscaling, vertical autoscaling, and/or combined horizontal and vertical autoscaling strategies. The autoscaler module 260 receives structured scaling recommendations that specify parameters such as per-pod resource requests, target utilization thresholds, and desired replica counts from the recommendation handler module 240, and applies these parameters by interfacing with native autoscaling components, such as Kubernetes autoscaling components, e.g., HPA and VPA.

In horizontal autoscaling mode, the autoscaler module 260 adjusts the replica count of a workload to meet predicted total demand. It may do so by updating HPA configuration objects or by directly modifying deployment or replica set specifications based on the predicted desired replica count received from the recommendation handler module 240. In configurations where dynamic HPA parameter prediction is enabled, the autoscaler module 260 may also modify HPA objects to reflect predicted values for minimum replica count, maximum replica count, and target CPU utilization, thereby allowing Kubernetes to perform scaling actions within those boundaries.

In vertical autoscaling mode, the autoscaler module 260 adjusts container resource requests based on per-replica usage forecasts generated by the recommendation handler module 240. It may update VPA recommendation objects or directly initiate updates to container specifications, triggering in-place resource adjustments or pod restarts, depending on the underlying platform capabilities. The autoscaler module 260 may incorporate buffer ranges and enforcement rules to ensure that vertical adjustments occur safely and without unnecessary disruption.

In combined autoscaling mode, the autoscaler module 260 coordinates the application of both vertical and horizontal scaling actions based on predefined precedence rules. In some embodiments, the autoscaler module 260 treats horizontal scaling as the primary response mechanism to forecasted workload changes. When HPA scaling reaches a configured upper or lower bound, the autoscaler module 260 activates VPA adjustments to fine-tune per-pod capacity. For example, when predicted resource demand exceeds the capacity allowed by the maximum number of replicas, the autoscaler module 260 may increase the per-pod CPU or memory allocation via VPA to ensure sufficient provisioning. Conversely, when demand is below the capacity threshold of the minimum replica count, the module may reduce per-pod allocations to improve efficiency without reducing replicas.

In some embodiments, the autoscaler module 260 may enforce guardrails and anti-thrashing heuristics, including minimum scaling intervals, maximum step sizes, and cooldown windows, to prevent unstable oscillatory behavior. It may also perform consistency checks to validate that recommendations are still relevant based on current workload state and telemetry. In some embodiments, the autoscaler module 260 logs all scaling actions and transmits performance metrics-such as realized utilization, scale latency, and error margins-back to the recommendation handler module 240 or the interface module 270. These metrics contribute to the continuous feedback loop used for refining future predictions and autoscaling strategies.

In some embodiments, the autoscaler module 260 is an execution engine that implements resource scaling decisions by interfacing with Kubernetes autoscaling components, including both HPA and VPA systems. Unlike traditional reactive autoscalers that respond to resource usage changes after they occur, the autoscaler module 260 operates proactively by leveraging seasonality-based predictions and recommendations to anticipate future resource demands and preemptively adjust resource allocation before demand spikes or valleys materialize. The autoscaler module 260 receives structured recommendations from the recommendation handler module 240 and translates these recommendations into specific Kubernetes resource modifications, including container resource request and limit adjustments via VPA mechanisms, and replica count modifications via HPA mechanisms.

For vertical scaling operations, the autoscaler module 260 interfaces with VPA controllers to dynamically adjust CPU, memory, and other resource allocations for individual containers within pods. The autoscaler module 260 applies the calculated resource request values determined through the prediction approaches (next three normalized, period aware normalized, or top periods aware normalized) by updating VPA recommendation objects, which subsequently trigger pod resource specification updates during pod restart cycles or through in-place resource adjustment mechanisms where supported.

For horizontal scaling operations, the autoscaler module 260 coordinates with native Horizontal Pod Autoscaler (HPA) systems through multiple operational modes. In a first mode, the autoscaler module 260 directly controls replica counts by updating deployment or replica set specifications based on predicted resource demands using either Native HPA Prediction or automation system 110's HPA Prediction algorithms. In a second mode, the autoscaler module 260 implements Dynamic HPA Parameters Prediction by configuring HPA objects with dynamically calculated minimum replica counts, maximum replica counts, and target utilization percentages, allowing native HPA controllers to make scaling decisions within the predicted optimal parameters.

In some embodiments, when both VPA and HPA are enabled for a workload, the autoscaler module 260 may implement a coordinated scaling strategy that prioritizes horizontal scaling as the primary mechanism while utilizing vertical scaling for edge cases or vice versa. In some embodiments, the autoscaler module 260 monitors HPA scaling boundaries and triggers VPA adjustments when horizontal scaling reaches configured limits, such as when maximum replica counts are reached (triggering vertical scale-up to handle additional load) or when minimum replica counts are reached (triggering vertical scale-down to improve resource efficiency). The autoscaler module 260 incorporates breaking point analysis to prevent ineffective vertical scaling beyond application-specific resource utilization limits, ensuring that scaling decisions remain within practical operational boundaries.

The autoscaler module 260 implements safety mechanisms including gradual scaling transitions, stability buffers to prevent oscillatory behavior, and rollback capabilities for reverting scaling decisions that result in performance degradation. The autoscaler module 260 maintains scaling event logs and performance metrics that are fed back to the feedback recommendation handler module 240 for continuous improvement of prediction accuracy and scaling effectiveness. Through its proactive resource management approach, the autoscaler module 260 enables cloud environments to anticipate and adapt to workload demands more effectively than reactive approaches, reducing response delays, improving resource utilization efficiency, and enhancing overall system reliability while minimizing both over-provisioning waste and under-provisioning performance impacts.

The data store 250 may be a columnar database system, such as ClickHouse™ (CH), optimized for time-series data storage and retrieval of forecast predictions and resource recommendations. The data store 250 is configured to store seasonality predictions generated by the seasonality handler module 220, including predicted resource usage values at multiple percentiles (e.g., 50^{th}, 80^{th}, 90^{th} percentiles), dominant frequency components identified through FFT analysis, energy ratios, and associated seasonal pattern metadata for each workload. The data store 250 may also maintain historical prediction accuracy metrics, including sMAPE (symmetric Mean Absolute Percentage Error), RMSE (root mean square error), and MAE (mean absolute error) values, enabling the system to evaluate and improve forecasting performance over time.

In some embodiments, the data store 250 may also store resource allocation recommendations generated by the recommendation handler module 240, including VPA resource request values, HPA replica counts, target utilization percentages, and scaling timing parameters for each workload. The columnar structure of the data store 250 enables efficient querying and retrieval of prediction data across different time windows and workload identifiers, supporting the recommendation handler module 240's regular interval operations. The data store 250 implements data retention policies to manage storage capacity while preserving sufficient historical data for seasonality analysis, typically maintaining several weeks of prediction data to enable continuous refinement of forecasting models and seasonal pattern detection across varying workload characteristics.

The interface module 270 is configured to facilitate interaction between the autoscaling prediction module 112 and external components, users, and monitoring systems. In some embodiments, the interface module 270 may implement API endpoints that enable external systems to query workload seasonality status, retrieve prediction data, and access scaling recommendations. In some embodiments, the interface module 270 may provide webhook interfaces to notify external monitoring platforms of scaling events and prediction updates.

In some embodiments, the interface module 270 exports metrics and performance data to external monitoring platforms such as Prometheus™, Grafana™, and DataDog™ providing comprehensive observability of prediction accuracy and scaling effectiveness. The interface module 270 includes a web-based dashboard interface that visualizes workload seasonality patterns, prediction accuracy metrics, and historical scaling decisions, and offering configuration management capabilities that allow administrators to adjust FFT parameters, energy ratio thresholds, and prediction approach selection for individual workloads.

In some embodiments, the interface module 270 implements real-time monitoring interfaces displaying current versus predicted resource usage with graphical overlays and alert notification systems that send scaling event notifications via email, Slack™, or other communication channels.

In some embodiments, for internal system coordination, the interface module 270 may provide message queuing interfaces for asynchronous communication between the seasonality detection module 230, recommendation handler module 240, and autoscaler module 260, along with event bus interfaces that coordinate the timing of prediction updates, recommendation generation, and scaling execution.

In some embodiments, the interface module 270 implements data synchronization mechanisms ensuring consistency between prediction data stored in the data store 250 and active scaling configurations, while maintaining feedback loop interfaces that collect scaling outcomes and performance data to continuously improve prediction accuracy.

In some embodiments, the interface module 270 may provide administrative functions including workload registration interfaces for onboarding new workloads, override and manual control interfaces allowing temporary disabling of predictions or manual parameter adjustments, A/B testing capabilities for comparing predictive scaling performance against traditional reactive scaling methods, and audit and compliance interfaces that maintain logs of all scaling decisions and configuration changes for regulatory and operational requirements.

FIG. 2B illustrates an example process flow for generating and utilizing seasonality-based predictions to inform resource scaling recommendations for workloads in a containerized computing environment, in accordance with one or more embodiments. As shown, a seasonality handler 220 is configured to detect seasonality in workload resource usage and generating forward-looking predictions. The seasonality handler 220 retrieves CPU usage metrics for each workload from a metrics module 210 or a telemetry system, such as Mimir. These metrics represent historical resource usage data collected over a defined analysis window. The seasonality handler 220 analyzes the retrieved data to determine whether the workload exhibits seasonality. In some embodiments, the seasonality handler applies a frequency-domain analysis, such as a Fast Fourier Transform (FFT), to compute the dominant frequency components of the signal. An energy ratio is calculated to quantify the contribution of those components to the overall variance in usage.

In response to determining that the energy ratio exceeds a predefined threshold (e.g., 0.7), the workload is classified as seasonal, and a corresponding usage prediction is generated. The predictions may also be stored in a data store 250, such as ClickHouse™ (CH), which may be implemented as a columnar or time-series database optimized for retrieval and querying of forecast data.

A recommendation handler 240 is invoked at regular intervals (e.g., every 30 minutes per workload) to determine updated resource scaling recommendations. The recommendation handler 240 retrieves and applies the stored prediction from CH 250 to generate a resource recommendation. In response to determining that the workload is seasonal, the recommendation handler 240 retrieves and applies the stored prediction from the CH 250 to generate a resource recommendation. Otherwise, the recommendation handler 240 obtains real-time usage metrics from Mimir 210 and generates recommendation using conventional logic (e.g., based on historical percentiles or reactive thresholds).

A snapshot handler 230 operates on a longer cadence (e.g., once daily per workload) to assist in managing workload state, triggering the seasonality handler 220 to perform updated analyses based on newly ingested usage data.

As such, this architecture enables adaptive autoscaling behavior wherein predictive scaling recommendations are automatically applied to workloads exhibiting seasonal behavior, while traditional methods continue to govern non-seasonal workloads. The resulting system improves resource efficiency while preserving robustness across diverse workload patterns.

### Example Time-Series Workload CPU Usage

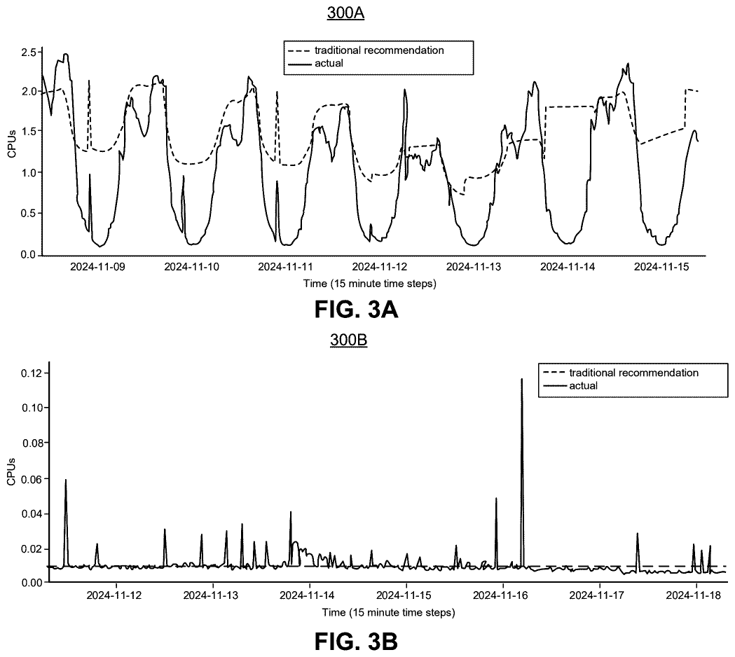

FIG. 3A illustrates an example time-series plot 300A of a workload CPU usage and a corresponding resource allocation recommendation generated by an existing optimization system, in accordance with one or more embodiments. As illustrated, the CPU usage line shown in FIG. 3A exhibits strong periodicity, meaning that there are clear, repeating cycles in the workload demand. The existing optimization system recommendation line follows a pattern but lags significantly from the real workload demand. This is because the existing optimization system is reactive rather than predictive.

FIG. 3B illustrates another example time-series plot 300B of a workload CPU usage and a corresponding resource allocation recommendation generated by the existing optimization system, in accordance with one or more embodiments. Contrary to the pattern shown in FIG. 3A, the CPU usage here is erratic and does not exhibit clear cycles. The existing optimization system also fails to recommend different resource allocation at different times to handle the resource demand spikes shown in FIG. 3B.

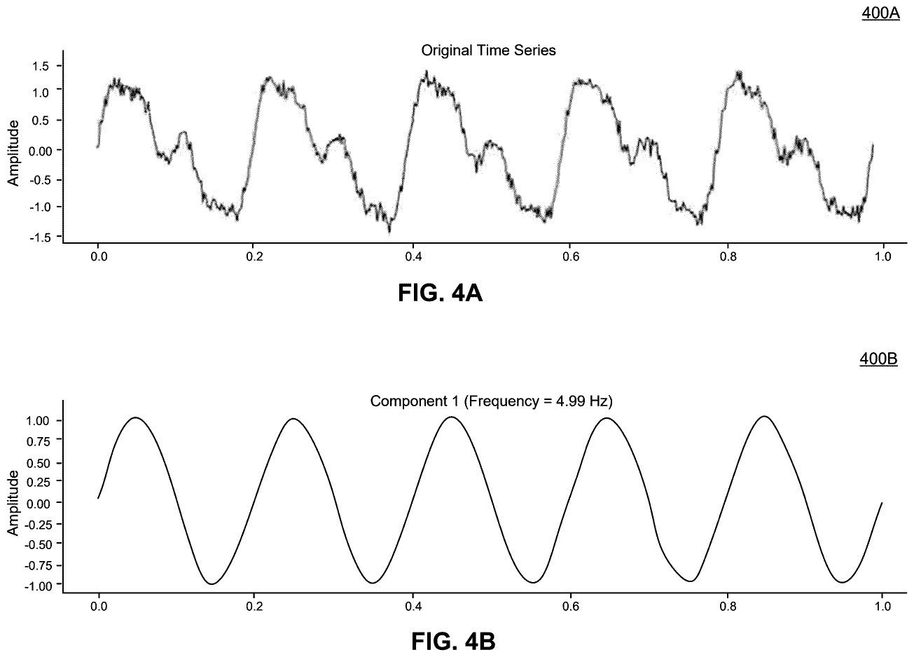

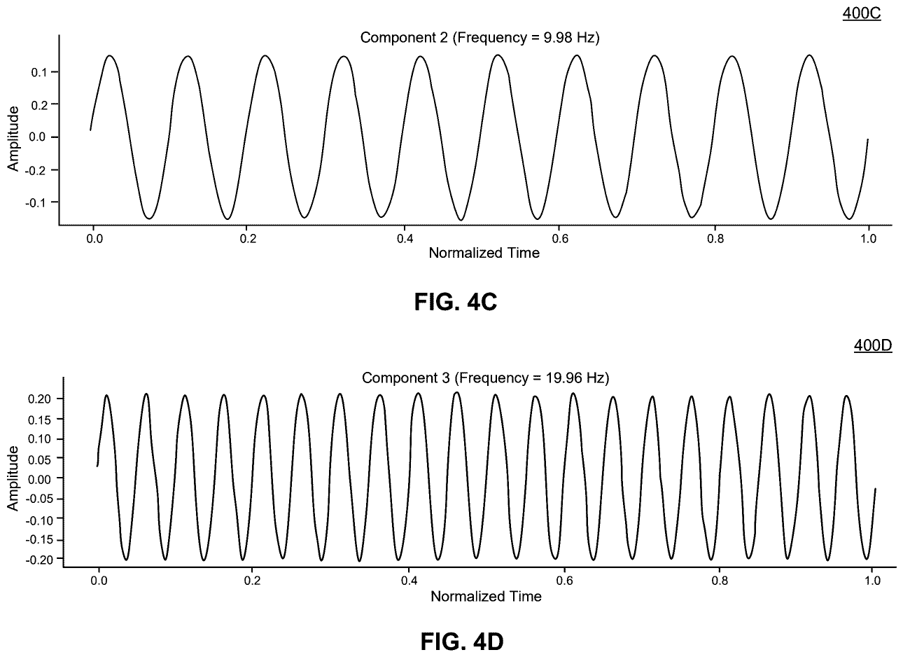

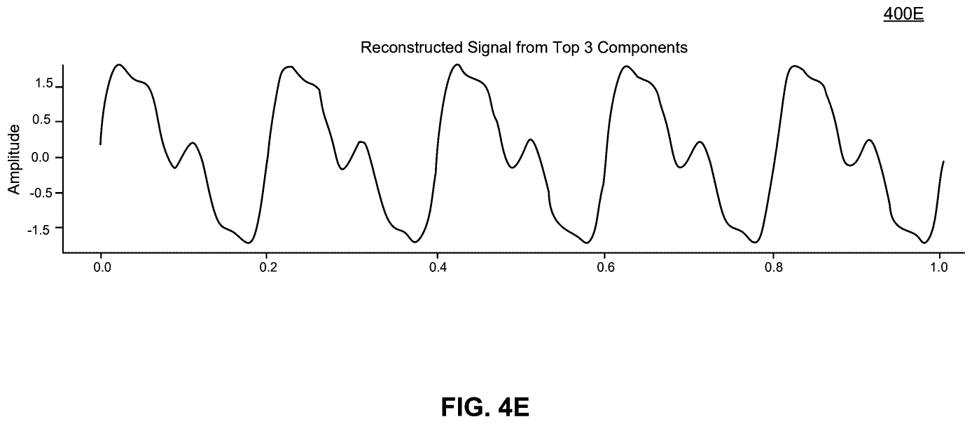

Unlike the existing optimization system, the seasonality handler module 220 described herein applies Fourier transform to each of these different workload time series, which may be corresponding to CPU usage, GPU usage, memory usage, disk I/O, network bandwidth, and/or other resource usage metrics, to decompose a time-series signal into its dominant frequency components, i.e., sinusoidal waves. FIGS. 4A-4E illustrate an example workload CPU usage time-series being divided into multiple frequency components, which can then be combined together to predict future workload CPU usage.

FIG. 4A illustrates time series 400A corresponding to a workload CPU usage, in accordance with some embodiments. FIGS. 4B-4D illustrate sinusoidal waves 400B, 400C, 400D corresponding to top three frequency components extracted from the time series 400A of the workload CPU usage. As illustrated, the original time series 400A has an amplitude oscillating between +1.5 and −1.5 (shown in FIG. 4A); the first component has a frequency of 4.99 Hz and an amplitude oscillating between +1.0 and −1.0 (shown in FIG. 4B); the second component has a frequency of 9.98 Hz and an amplitude oscillating between +0.8 and −0.8 (shown in FIG. 4C); and the third component has a frequency of 19.98 Hz and an amplitude oscillating between +0.3 and −0.3 (shown in FIG. 4D).

For example, the frequency component shown in FIG. 4B corresponds to a power magnitude of 0.5 (=0.5*12); the frequency component shown in FIG. 4C corresponds to a power magnitude of 0.32 (=0.5*0.8²); and the frequency component shown in FIG. 4D corresponds to a power magnitude of 0.045 (=0.5*0.3²). Based on these power magnitudes of the top three frequency components and a total power of the original time series (shown in FIG. 4A), an energy ratio of the top three frequency components can be determined.

The seasonality determination module 224 also determines whether the energy ratio is greater than a predetermined threshold (e.g., 80%). In response to determining that the energy ratio of the top a few frequency components are greater than the predetermined threshold, the seasonality handler module 220 determines that the workload is seasonal.

In response to determining that the workload is seasonal, the recommendation handler module 240 may apply an inverse Fourier transform to the top three frequency components to generate a forecast time series, which can be used to forecast future resource consumptions. FIG. 4E illustrates a forecasting time series 400E of a predicted workload CPU usage that combines the top three frequency components 400B, 400C, 400D extracted from the time series 400A, in accordance with one or more embodiments. Notably, the forecasting time series 400E resembles the original time series 400A closely. This forecasting time series 400E can be used to predict future workload resource usage, and guide autoscaler module 260 to proactively scale resources.

As shown in FIGS. 4A-4E a few top frequency components of a workload has a high energy ratio (e.g., greater than 80%), the few top frequency components can effectively reconstruct the original time series, providing highly accurate predictions.

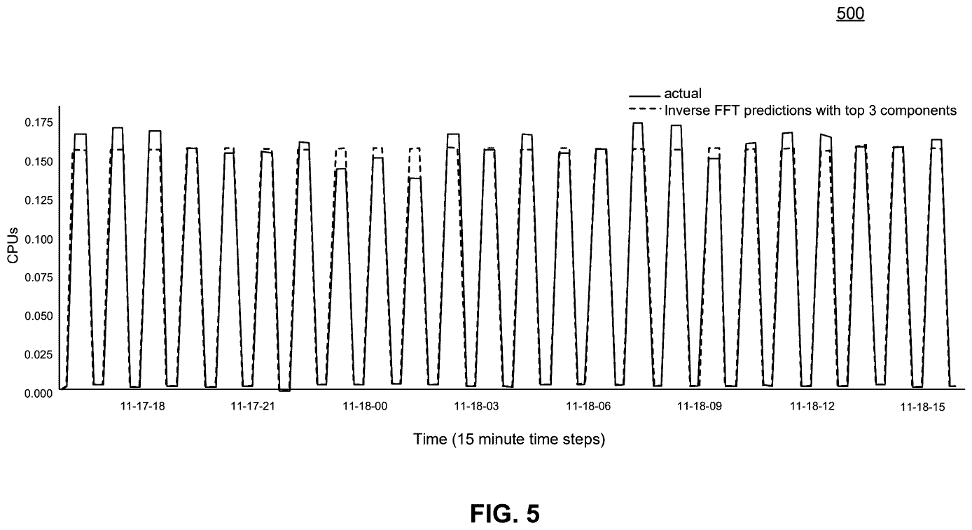

FIG. 5 illustrates another example time series 500 of a workload with strong seasonality, such that the forecasting time series closely resembles the original time series, in accordance with one or more embodiments. In FIG. 5, the energy ratio of the top few frequency components is 98%, indicating that most of the variance in the workload CPU usage can be explained by just the top few frequency component. The actual time series line and the forecasting time series line closely align with each other.

FIGS. 6A-6E illustrates comparative performance metrics between recommendations generated by existing systems and recommendations generated based on transformer-based predictions for resource provisioning in accordance with one or more embodiments. Each vertical arrow line (from left to right) corresponds to the 30th percentile, 50th percentile, 80th percentile, and 90th percentile.

FIG. 6A is a plot 600A depicting percentage under-provisioning differences between existing system and Chrono-based system across different percentiles. As described above, under-provisioning measures how often the system does not allocate enough CPU resources, leading to performance issues. FIG. 6A shows that transformer-based predictions reduce under-provisioning significantly across all percentiles. The vertical arrows indicate the reduction in under-provisioning as percentile values increase.

FIG. 6B is a plot 600B depicting unit number under-provisioning differences between existing system and Chrono-based system across different percentile. Similar to FIG. 6A, transformer-based recommendations show lower under-provisioning compared to the existing system. Numbers above the vertical arrows (e.g., 2986, 3104) indicate how many CPU under-provisions observed at different percentiles. Lower values in transformer-based prediction indicate better workload handling.

FIG. 6C is a plot 600C depicting percentage sMAPE (symmetric Mean Absolute Percentage Error) differences between existing system and Chrono-based system across different percentiles. Lower sMAPE means better performance. The transformer-based system shows a much lower sMAPE across percentiles, indicating that transformer-based system provides a much more reliable forecasts for resource usage.

FIG. 6D a plot 600D depicting percentage over-provisioning differences between existing system and Chrono-based system across different percentiles. As described above, over-provisioning measures how often the system allocates CPUs, exceeding actual needs, leading to inefficiencies. FIG. 6D shows that transformer-based system reduces over-provisioning significantly across different percentiles.

FIG. 6E is a plot 600E depicting unit number over-provisioning differences between existing system and Chrono-based system across different percentile. Similar to FIG. 6D, transformer-based system shows a more controlled increase in over-provisioning at higher percentiles compared to the existing system.

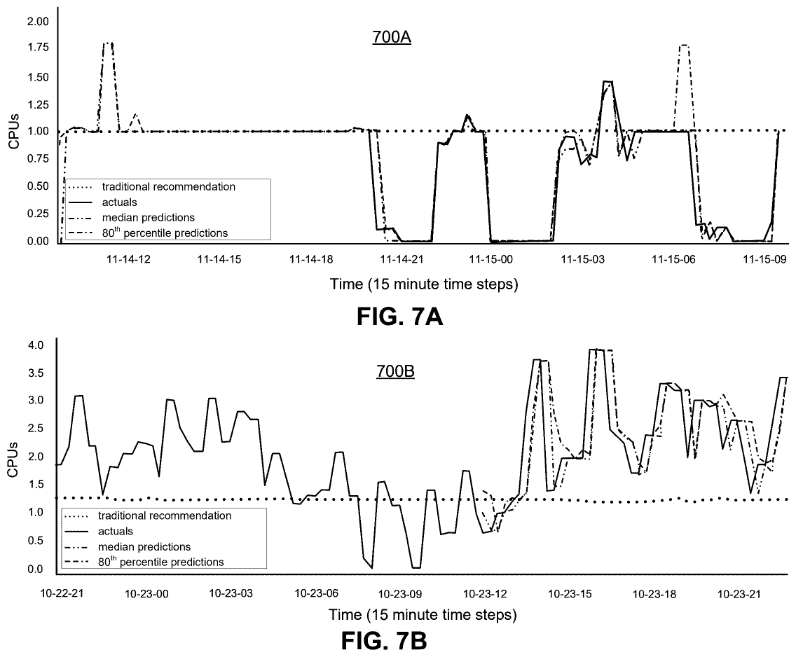

FIG. 7A is a plot 700A depicting a workload with intermittent CPU usage with sharp spikes and long idled periods. The existing recommendation maintains a static CPU allocation, failing to adapt to fluctuating demand. In contrast the transformer-based system closely tracks the actual workload consumption, anticipating sudden surges and periods of inactivity. Notably, during idle periods, transformer-based system predicts near-zero CPU usage, aligning with actual data, while the static existing system results in resource over-provisioning. During high-demand moments, the 80^{th} percentile forecast effectively captures peak CPU spikes, which helps prevent under-provisioning.

FIG. 7B is a plot 700B depicting another highly dynamic workload, where CPU demand remains consistently high with some variations. The existing system recommendation remains flat and fails to react to the volatility in CPU consumption, potentially leading to performance degradation during demand spikes and wasteful over-provisioning during lower-demand intervals. In contrast, the transformer-based system tracks the rapid workload fluctuation with high accuracy, adjusting to workload surges and dips. The 80^{th} percentile prediction effectively captures peak resource demands. These examples demonstrate that transformer-based predictive forecasting system offers a much more adaptive, intelligent resource management solution, improving the functioning of the computing systems.

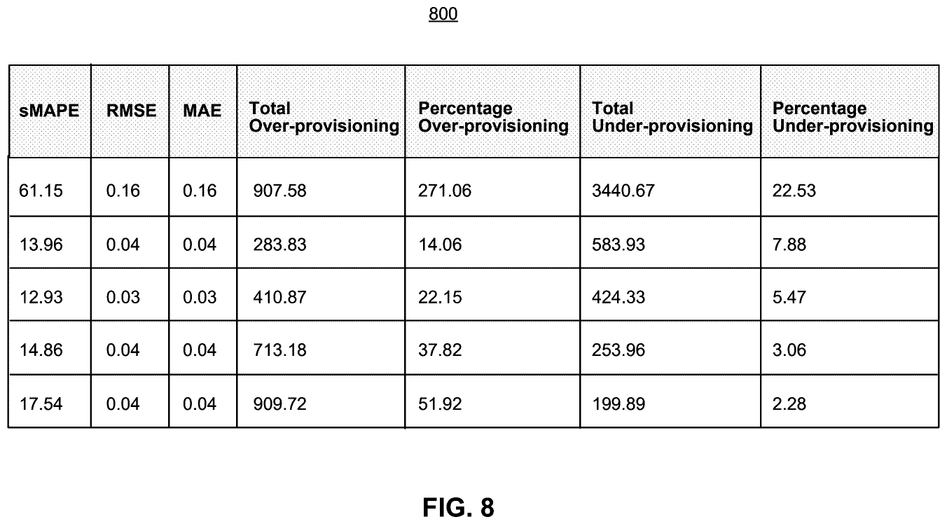

FIG. 8 is a table 800, presenting a quantitative evaluation of forecasting accuracy and resource allocation efficiency of the forecasting system described herein, comparing key performance metrics across at different time periods, in accordance with one or more embodiments. The table includes sMAPE (symmetric mean absolute percentage error), RMSE (root mean square error), and MAE (mean absolute error)—which are metrics for measuring predictive accuracy. Lower values for RMSE and MAE indicate higher precision in workload forecasting. Additionally, the table evaluates total and percentage over-provisioning and total and percentage under-provisioning, which are key indicators of resource allocation efficiency.

Each row represents data points from different time periods. At the beginning (first few rows), the system may not have sufficient time-series data to accurately forecast future resource consumption. Over time (the last few rows), the system accumulates more time-series data, thereby improving its ability to accurately forecast future resource consumption. The first row shows a high sMAPE (61.15), indicating poor predictive accuracy, which results in significant total under-provisioning (3440.67) and over-provisioning (907.58). However, as we move down the table, sMAPE decreases, and prediction errors (RMSE and MAE) also decrease, suggesting improvements in forecasting accuracy. The last row, with an sMAPE of 17.54 and the lowest under-provisioning percentage (2.28%), demonstrates a more balanced and efficient resource allocation strategy, minimizing both wasted capacity and performance risks. This suggests that more accurate predictive models (e.g., transformer-based approaches) can gradually enhance workload management by reducing over- and under-provisioning of resources, leading to optimized cloud resource utilization.

### Example Prediction Visualizations and Autoscaling Implementations

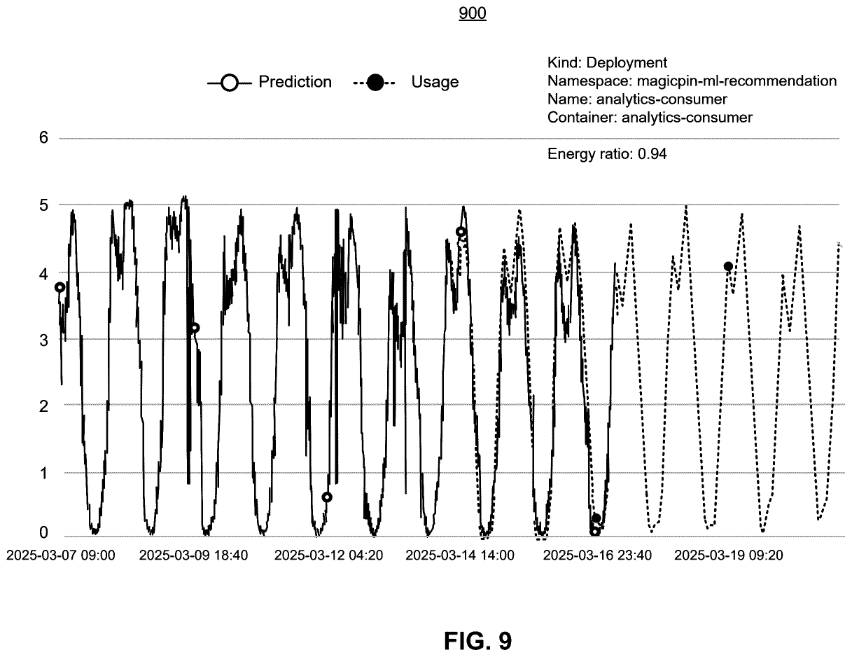

FIG. 9 illustrates an example time-series visualization 900 of workload resource consumption and predictive forecasting for a containerized application, in accordance with one or more embodiments. The visualization 900 displays CPU usage patterns over a time period from March 7 to Mar. 19, 2025, with measurements taken at regular intervals. The visualization includes two overlapping time series: a first line representing actual historical CPU usage (“Usage”) and a second line representing predicted CPU usage (“Prediction”). The workload corresponds to a deployment named “magicpin-ml-recommendation” in the “analytics-consumer” namespace and container. As shown in FIG. 9, the system has determined an energy ratio of 0.94, indicating strong seasonality in the workload pattern. The actual usage data exhibits clear periodic behavior with regular peaks reaching approximately 5 CPU units and valleys dropping to near 0 CPU units, demonstrating a consistent daily or multi-day cycle. The prediction line, generated by the recommendation handler module 240, closely tracks and anticipates these seasonal patterns, particularly in the latter portion of the time series where the red prediction line overlaps with future time periods. This high energy ratio of 0.94 confirms that the dominant frequency components capture 94% of the total signal energy, validating the effectiveness of the FFT-based seasonality detection approach and enabling accurate proactive resource provisioning for this highly seasonal workload.

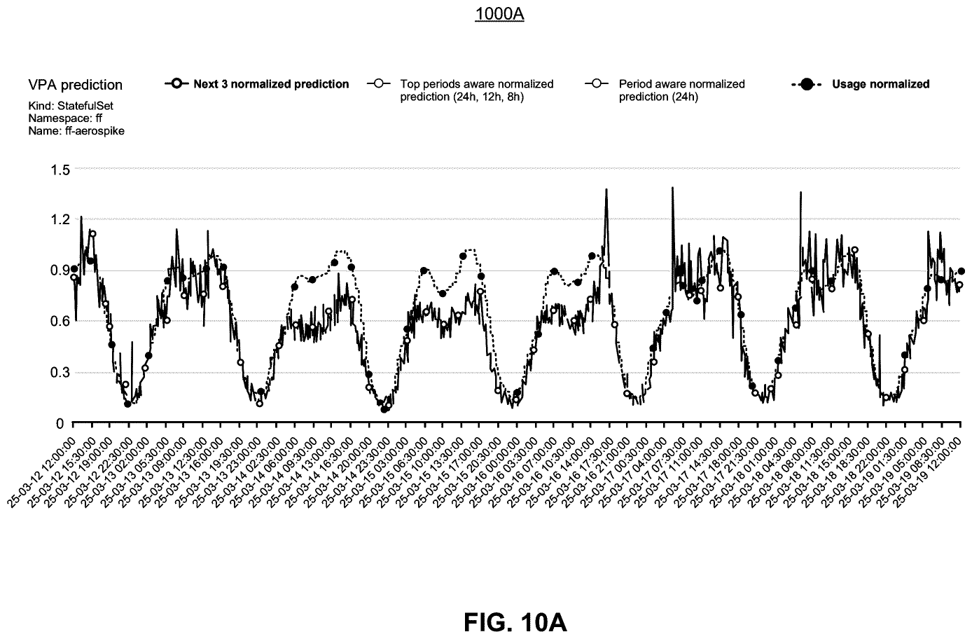

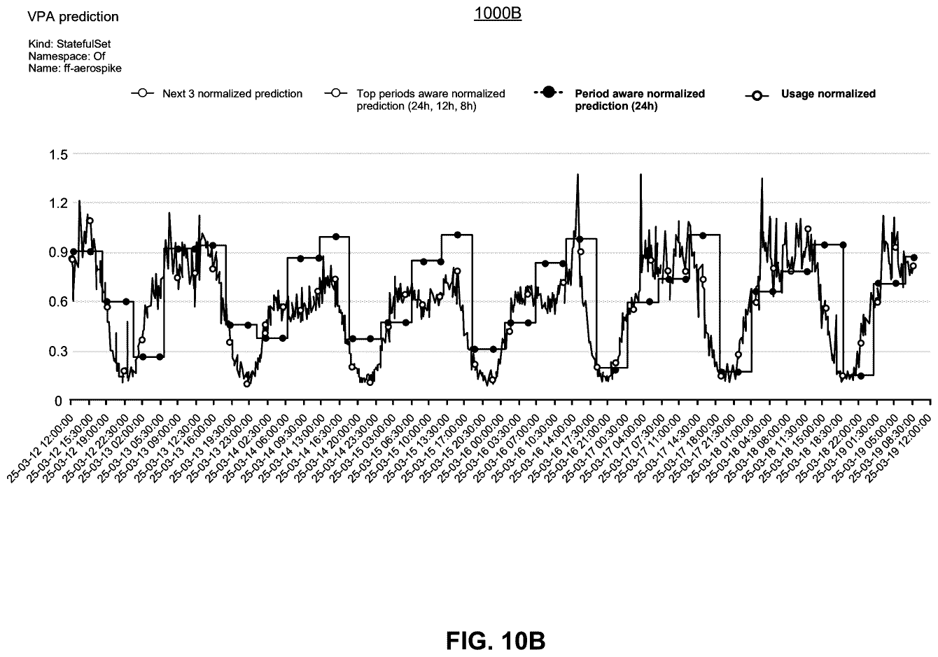

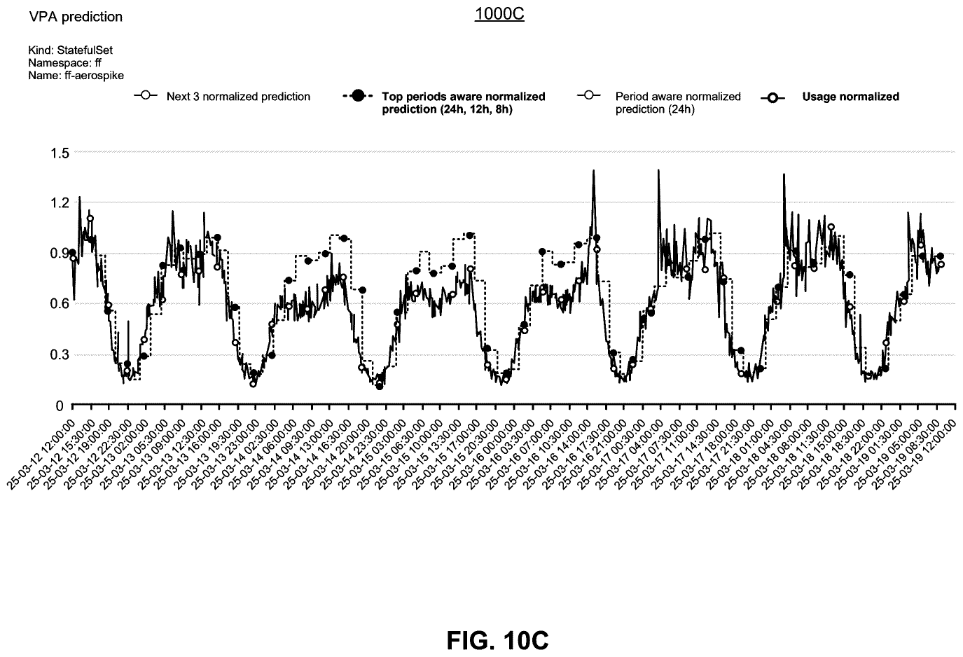

FIG. 10A illustrates a VPA (Vertical Pod Autoscaler) prediction visualization 1000A comparing different prediction approaches for resource allocation, in accordance with one or more embodiments. The visualization 1000A displays CPU usage patterns for a StatefulSet workload named “fl-aerospike” over a time period from December 13 to Dec. 14, 2025. The visualization includes two lines: a first line representing actual normalized CPU usage, a second line showing the Next 3 normalized prediction approach. The actual usage pattern exhibits strong diurnal seasonality with CPU consumption varying between approximately 0.15 and 1.4 units, featuring regular peaks and valleys that repeat on a daily cycle. As shown, the Next Three Normalized prediction approach results in periods of both over-provisioning and under-provisioning. In some embodiments, the Next Three Normalized approach selects the maximum predicted usage from a fixed, forward-looking time window-typically comprising the next three forecast points (e.g., representing the next 30 minutes). This maximum value is then normalized by the current replica count to generate a per-pod resource recommendation. While this approach is computationally lightweight and effective for short-term forecasting, it lacks sensitivity to longer-term periodic trends.

As illustrated in FIG. 10A, over-provisioning arises when the maximum value in the short look-ahead window corresponds to a transient spike that does not represent sustained usage. In such cases, the prediction overestimates resource demand during usage troughs or transitional periods, leading to the allocation of excess resources and reduced utilization efficiency. Conversely, under-provisioning occurs during the onset of cyclical peaks when the true workload increase lies just beyond the fixed look-ahead window. Because the Next Three Normalized method does not incorporate longer-range trend information or backward-looking context, it fails to anticipate steep upward demand slopes. This results in delayed scaling actions and potential resource shortfall during early stages of peak load intervals. These limitations make the Next Three Normalized approach best suited for workloads with stable or bursty behavior, but less optimal for workloads exhibiting well-defined cyclical seasonality.

FIG. 10B illustrates a VPA prediction visualization 1000B for the same workload depicted in FIG. 10A, demonstrating the behavior of the Period Aware Normalized prediction approach in accordance with one or more embodiments. The visualization 1000B includes a first line representing actual normalized CPU usage and a second line representing the predicted per-replica usage based on the dominant seasonal component, which in this case corresponds to a 24-hour periodic pattern. The Period Aware Normalized approach leverages the most significant frequency component extracted through Fourier analysis to determine both the prediction interval and the look-ahead/look-back window. In some embodiments, the recommendation interval is set to one-fourth of the dominant period, and the prediction window is set to one-half of that period. As shown, this approach results in a stepped prediction pattern that maintains relatively constant resource allocation levels during sustained high-usage and low-usage phases, with transitions occurring at points aligned with the expected cycle boundaries.

The stepped nature of the prediction enables the system to anticipate workload changes in advance, resulting in proactive scaling that precedes observed changes in actual demand. For instance, the prediction transitions often occur just before each usage peak or valley, indicating that the recommendation handler module has successfully inferred the cyclical workload pattern. Compared to the Next Three Normalized approach shown in FIG. 10A, the Period Aware Normalized method reduces unnecessary allocation changes by avoiding short-term noise, and provides improved performance coverage by aligning resource provisioning with the true underlying cycle. This approach is particularly effective for workloads with a single dominant seasonal pattern, such as daily traffic cycles, and strikes a balance between resource efficiency and responsiveness by adapting to changes at regular, predictable intervals.

FIG. 10C illustrates a VPA prediction visualization 1000C that emphasizes the behavior of the Top Periods Aware Normalized prediction approach, in accordance with one or more embodiments. This visualization 1000C also includes a first line representing actual normalized CPU usage and a second line representing the predicted per-replica usage computed using multiple significant frequency components simultaneously. In some embodiments, the recommendation handler module 240 identifies and retains the top N dominant frequencies—e.g., frequencies corresponding to 24-hour, 12-hour, and 8-hour periods—and generates predictions using the composite effect of these components. The shortest of these periods is used to define the recommendation interval and prediction window, while the cumulative signal is used to model the overlapping seasonal effects present in complex workloads.

As illustrated, the Top Periods Aware Normalized prediction line exhibits a more nuanced and variable step pattern compared to FIG. 10B, capturing not only the major daily workload oscillations but also intra-day fluctuations driven by secondary and tertiary periodic components. For example, during peak intervals, the prediction exhibits minor rises and falls that track intra-day variation, such as morning and afternoon surges. This multi-period approach improves prediction granularity and allows for precise adjustments to per-pod resource allocation throughout the day. By reflecting the composite structure of real-world seasonal patterns, the Top Periods Aware method reduces the risk of both under-provisioning during sub-peak intervals and over-provisioning during low-amplitude phases. This makes it especially suitable for workloads with compound seasonality, such as services with daily, half-daily, and hourly usage patterns, enabling robust and fine-tuned autoscaling decisions.

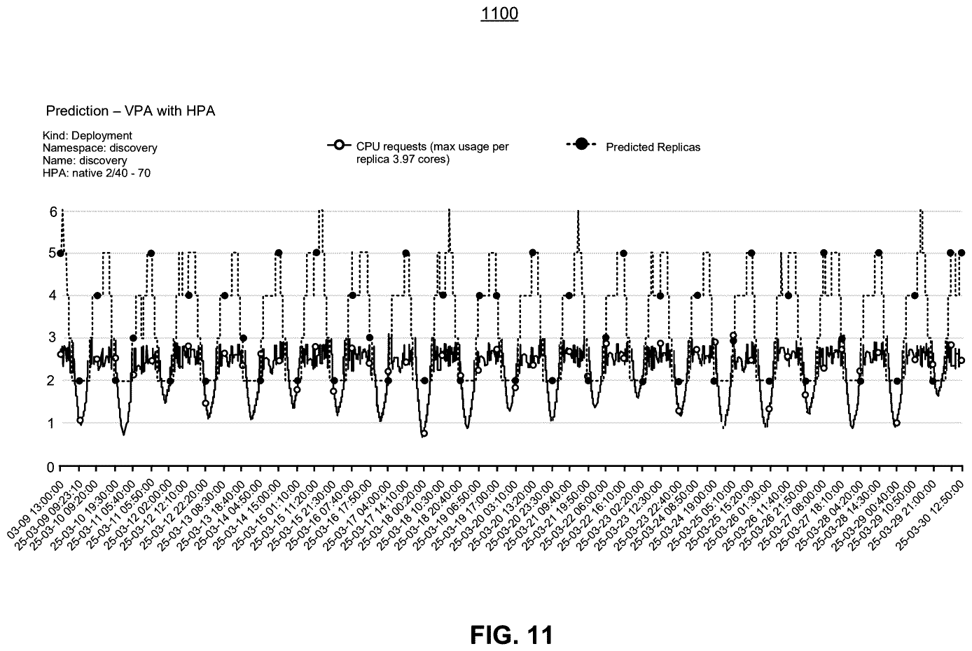

FIG. 11 illustrates a prediction visualization 1100 for a containerized workload operating under a coordinated vertical and horizontal autoscaling strategy, in accordance with one or more embodiments. The workload corresponds to a deployment named “discovery,” with native Kubernetes Horizontal Pod Autoscaler (HPA) configured to operate between 2 and 70 replicas. The visualization 1100 spans a multi-day period from September 18 to Sep. 26, 2025, and presents two distinct prediction metrics: a first line representing predicted CPU requests per pod, with maximum usage per replica capped at 3.97 cores; and a second line indicating the predicted number of replicas required to meet aggregate workload demand. The underlying CPU usage pattern exhibits pronounced daily seasonality, with recurrent demand peaks reaching approximately 2.5-3 cores per pod and valleys dropping to around 1 core, demonstrating a cyclical compute profile.

The prediction results shown in FIG. 11 shows the behavior of the system when both VPA and HPA mechanisms are active. During periods where the per-replica CPU forecast approaches or exceeds the configured vertical scaling limit (3.97 cores), the autoscaler module prioritizes horizontal scaling actions, increasing the number of replicas to maintain sufficient aggregate capacity. Conversely, during steady usage phases below the vertical cap, the system optimizes resource efficiency by scaling vertically, i.e., adjusting CPU requests for individual pods without increasing the replica count. This coordinated scaling model ensures that workloads are served at high utilization levels without breaching resource constraints, and prevents excessive replication in cases where vertical scaling is adequate.

Notably, the predicted replica count increases preemptively ahead of peak usage intervals, indicating that the autoscaling system leverages forecasted seasonality to anticipate surges. The periodic oscillation of replica counts, combined with the red CPU request curve flattening near the vertical ceiling, highlights the adaptive nature of the autoscaling logic, which transitions between vertical and horizontal scaling modes in response to forecast saturation. This dual-mode orchestration reduces under-provisioning during high-load periods and minimizes over-provisioning during troughs, enabling fine-grained autoscaling that respects per-container performance ceilings while ensuring workload availability and resource efficiency across varying usage conditions.

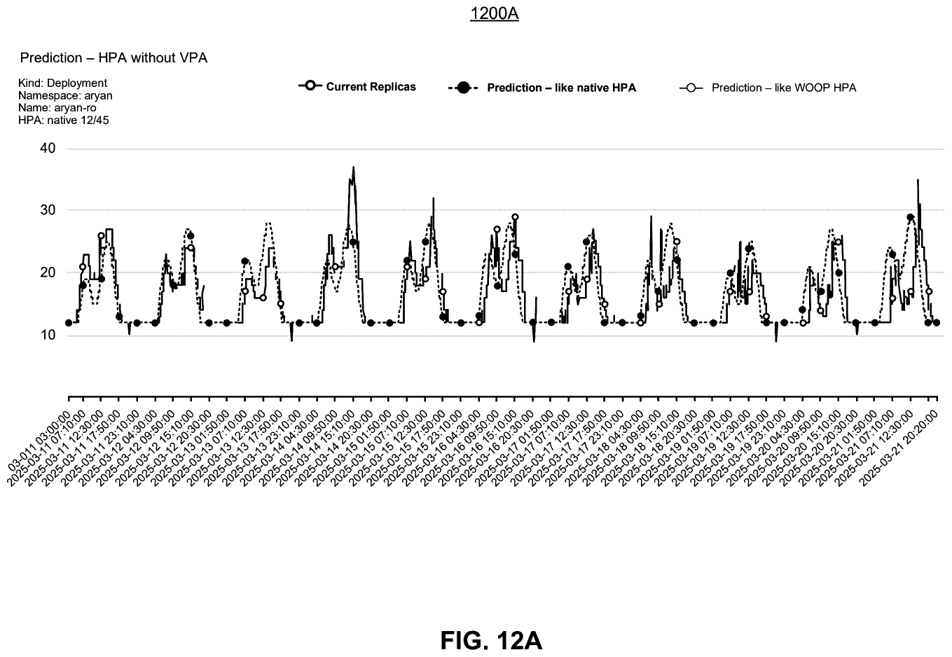

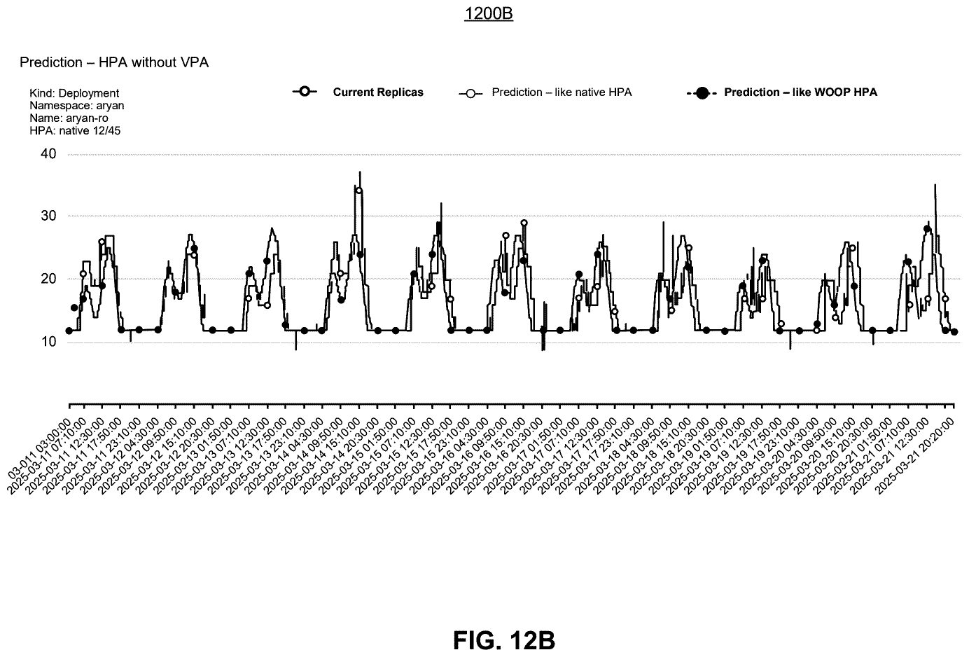

FIG. 12A illustrates a Horizontal Pod Autoscaler (HPA) prediction visualization 1200A for a containerized workload operating without vertical autoscaling, in accordance with one or more embodiments. The deployment, named “aryan,” is shown over a time period from November 9 to Nov. 29, 2025, with the native Kubernetes HPA configured with a minimum of 12 replicas and a maximum of 45 replicas. The visualization includes two lines: a red line representing the current number of replicas active in the cluster based on actual runtime scaling events; and a yellow line representing a prediction-like native HPA, which simulates how the Kubernetes HPA would behave if provided with forecasted CPU usage as input rather than observed real-time usage.

As described above, the native HPA prediction is computed based on Equation (3) above. In Equation (3), predictedCPUUsage represents the aggregate expected CPU consumption derived from FFT-based or machine learning forecasts, targetUtilization is a predefined or default CPU utilization threshold (e.g., 80%), and totalContainerRequests is the sum of all current per-container CPU requests. The prediction enforces minimum and maximum replica bounds and simulates how the native Kubernetes HPA logic would respond if it operated on future-oriented usage estimates.

As shown in FIG. 12A, the predicted replica line (second line) displays proactive adjustments to expected usage spikes and valleys, in contrast to the current replica line (first line), which reflects delayed and reactive behavior. For example, the second line begins to rise in advance of anticipated demand surges and decreases shortly after predicted workload troughs, demonstrating the advantage of feeding predictive CPU data into the autoscaler model. This anticipatory scaling reduces latency in response time and improves workload performance during peak intervals. By simulating the native HPA logic with predictive data inputs, the system enables infrastructure operators to evaluate the benefit of forecast-driven autoscaling behavior while maintaining compatibility with Kubernetes-native scaling algorithms.

FIG. 12B illustrates a Horizontal Pod Autoscaler (HPA) prediction visualization 1200B for a containerized workload operating without vertical autoscaling, using the Workload Optimization HPA Prediction approach, in accordance with one or more embodiments. The visualization 1200B presents autoscaling behavior for a deployment named “aryan” over a time period from November 9 to Nov. 29, 2025. Two lines are displayed: a first line representing the current number of replicas deployed in the system, and a second line representing the predicted number of replicas, computed using seasonality-informed CPU forecasts and a relative scaling model.

Unlike the native HPA prediction, which directly computes a desired replica count based on total predicted usage and fixed target utilization, the Workload Optimization HPA prediction implements a more sophisticated and adaptive scaling algorithm. Specifically, the system first calculates the average CPU usage per pod and the corresponding target CPU per pod based on configured container resource requests. It then computes a scaling factor using Equation (4) and a replica delta using Equation (5) above.

The Workload Optimization HPA logic applies this delta only if the absolute value is greater than or equal to one, ensuring that minor fluctuations do not trigger unnecessary scaling events. The delta is rounded to the nearest integer and subjected to configured minimum and maximum replica constraints.

As shown in FIG. 12B, the Workload Optimization prediction line (second line) exhibits anticipatory scaling behavior, with proactive adjustments that closely follow the cyclical nature of the workload. Compared to the red line representing actual replicas, the Workload Optimization prediction achieves smoother transitions and more stable scaling plateaus during both rising and falling workload phases. The blue prediction line demonstrates responsiveness not just to absolute predicted usage, but also to per-replica efficiency dynamics, allowing finer control over autoscaling in scenarios where the application has known constraints, such as single-threaded CPU limits or replica contention.

This approach enables context-aware, relative autoscaling that adapts to both workload size and structure, making it particularly effective for workloads exhibiting regular seasonal cycles with varying burst characteristics. By enforcing threshold-based scaling and integrating forecasted average pod usage, the Workload Optimization HPA model reduces oscillatory behavior and provides enhanced provisioning precision compared to traditional HPA logic. The visualization further shows that the Workload Optimization prediction remains within operational bounds while improving alignment between provisioning and predicted demand, ultimately enhancing cluster stability and resource efficiency.

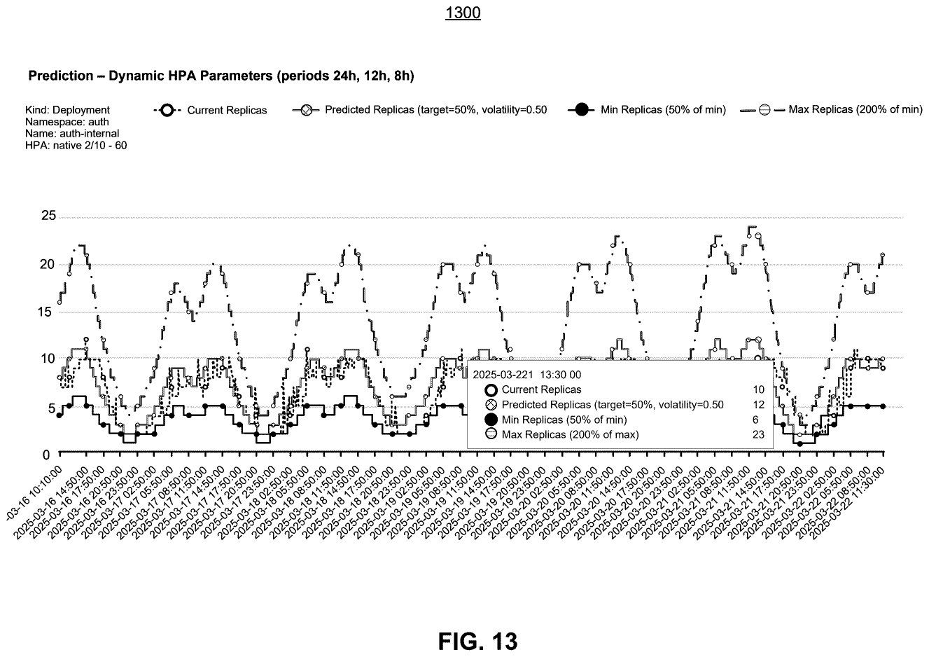

FIG. 13 illustrates a prediction visualization 1300 for dynamic Horizontal Pod Autoscaler (HPA) Parameters, demonstrating the use of forecasted workload demand to dynamically configure replica bounds and target utilization parameters for Kubernetes HPA, in accordance with one or more embodiments. The visualization 1300 corresponds to a deployment named “auth-internal” over a time period from March 9 to Mar. 27, 2025. The visualization includes four lines: a first line representing the current number of replicas active in the deployment; a second line representing the predicted number of replicas required to meet forecasted workload demand at a 50% target CPU utilization; a third line representing the dynamically predicted minimum replica count; and a fourth line representing the dynamically predicted maximum replica count.

In some embodiments, the system analyzes historical CPU usage using Fast Fourier Transform (FFT) to identify dominant seasonal components. The shortest significant frequency component is used to determine the autoscaling decision interval and to capture rapid usage fluctuations. For each prediction point, the system derives a target utilization percentage (within a range such as 50-85%) and dynamically computes the min and max replica bounds for Kubernetes HPA based on the forecasted usage and observed volatility. The minimum replica count may be set to 50% of the predicted replica value, while the maximum replica count may be set to 200%, ensuring both coverage and elasticity. These values are rounded and clamped to enforce replica stability.

The second predicted replica line closely tracks the anticipated usage patterns, increasing ahead of demand peaks and decreasing during forecasted troughs. The third and fourth lines (min and max replicas) fluctuate over time, expanding during peak intervals to allow headroom for scaling, and contracting during off-peak periods to conserve resources. This adaptive band constrains the behavior of the native Kubernetes HPA, allowing it to operate autonomously within a forecast-informed scaling envelope. The first line (current replicas) illustrates how the system's actual autoscaling response compares to the predicted guidance and dynamic bounds.

This approach enables a form of self-tuning autoscaler configuration, where both utilization thresholds and scaling limits evolve with workload behavior. By aligning these parameters to forecasted CPU usage and periodicity patterns, the system achieves more precise, efficient, and responsive horizontal scaling. The ability to dynamically adjust autoscaler constraints at runtime reduces under-provisioning during bursts and eliminates unnecessary over-provisioning during idle cycles, thereby optimizing workload availability and cloud resource consumption.

### Example Methods for Predictive Autoscaling in Containerized Computing Environment

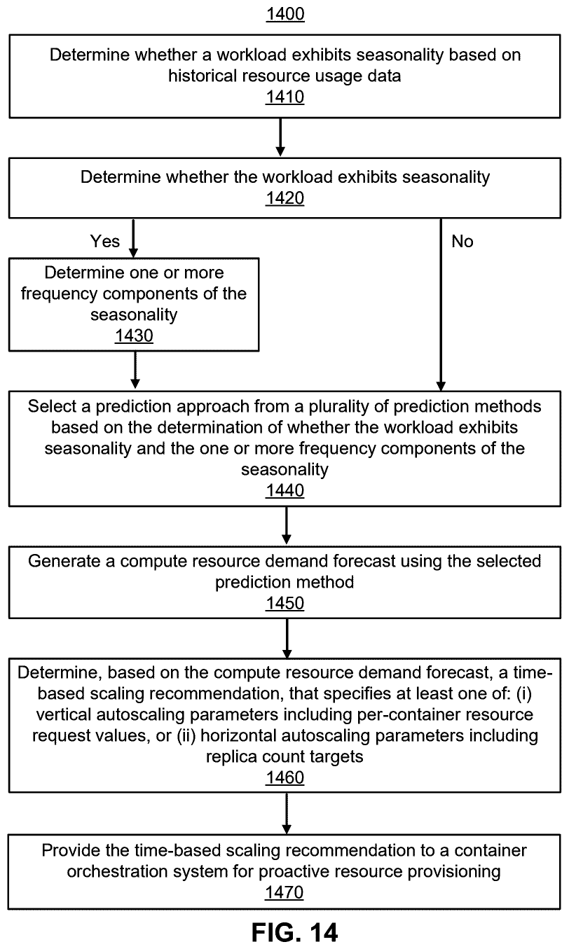

FIG. 14 is a flowchart of a method 1400 for predictive autoscaling in containerized computing environments, in accordance with one or more embodiments. In various embodiments, the method includes different or additional steps than those described in conjunction with FIG. 14. Further, in some embodiments, the steps of the method may be performed in different orders than the order described in conjunction with FIG. 14. The method described in conjunction with FIG. 14 may be carried out by the automation system 110 in various embodiments, while in other embodiments, the steps of the method 1400 are performed by any online system capable of performing these steps.

The automation system 110 determines 1410 whether a workload exhibits seasonality based on historical resource usage data. In some embodiments, the automation system 110 begins by analyzing historical compute resource usage data collected over a specified observation window to determine whether the workload exhibits seasonal patterns. This process may include retrieving time-series CPU utilization metrics for the workload from a telemetry or monitoring system, such as metrics module 210, Mimir, and applying statistical preprocessing to normalize and clean the data. In some embodiments, outliers and missing values may be addressed using imputation or exclusion techniques to ensure data quality

The automation system 110 determines 1420 whether the workload exhibits seasonality. In some embodiments, the time series data obtained from the metrics module 210 may be evaluated by the seasonality handler module 220 to identify the presence of cyclic behavior or repeating trends, which are indicative of workload seasonality. In some embodiments, the automation system 110 employs a frequency-domain transformation, such as a Fast Fourier Transform (FFT), to convert the time-domain signal into a spectrum of constituent frequencies. By analyzing the spectral energy distribution and quantifying the variance explained by dominant components, the system determines whether a substantial portion of the workload behavior can be attributed to periodic patterns.

In some embodiments, this determination is based on computing an energy ratio-a metric representing the proportion of total signal energy contained in the top frequency components relative to the overall signal. If the computed energy ratio exceeds a predefined threshold (e.g., 70%), the system 110 classifies the workload as seasonal. If the energy ratio does not meet the threshold, the system 110 proceeds with a non-seasonal analysis path. This classification step distinguishes true periodic trends from stochastic fluctuations or operational noise. In some embodiments, the determination may also incorporate heuristics or machine-learned thresholds that consider the magnitude, duration, and consistency of usage cycles across different time scales. The system 110 may further refine its classification by evaluating intra-day, daily, or weekly recurrence intervals and ruling out false positives arising from irregular spikes.

In response to determining that the workload exhibits seasonality, the automation system 110 determines 1430 one or more frequency components of the seasonality. In some embodiments, these components are extracted from the frequency-domain representation generated during the FFT analysis. Each frequency component corresponds to a sinusoidal signal with a specific period and amplitude that contributes to the overall workload pattern. The system 110 selects the most dominant components—typically those with the highest power magnitudes—and filters out components that fall outside configured frequency bounds to avoid overfitting or capturing noise. For example, cycles shorter than one hour or longer than one week may be excluded. The selected components form the basis for reconstructing a smoothed version of the usage pattern that retains meaningful periodicity. In some embodiments, up to three dominant components are retained, capturing compound seasonal behaviors such as daily and sub-daily usage fluctuations. These components inform subsequent predictive modeling and resource allocation logic.

The automation system 110 selects 1440 a prediction approach from a plurality of prediction methods based on the determination of whether the workload exhibit seasonality and the one or more frequency components of the seasonality. In response to the workload being classified as non-seasonal, the system 110 may select a fixed-window, look-ahead method such as the “Next Three Normalized” approach, which forecasts short-term usage peaks using a narrow, forward-only prediction window. Conversely, in response to a detection of a single dominant seasonal component, the system may employ a “Period Aware Normalized” prediction strategy that aligns resource recommendations with the expected inflection points of the recurring cycle. In response to detection of multiple significant frequency components, the system uses a “Top Periods Aware Normalized” approach, which integrates overlapping cycles to produce fine-grained, composite forecasts. The choice of prediction method influences both the look-back/look-ahead window parameters and the temporal granularity of the forecast. In some embodiments, the method is dynamically selected further based on workload volatility, historical accuracy metrics, and current configuration policies associated with the workload deployment.

The automation system 110 generates 1450 a compute resource demand forecast using the selected prediction method. This forecast may include a predicted CPU, memory, or other resource usage values for each container or pod within a workload. When a frequency-domain approach is used, the system performs an inverse Fourier transform (IFFT) on the selected dominant components to reconstruct a smoothed, forward-looking time series that represents anticipated usage. Alternatively, if a machine learning model is employed—such as a transformer-based time-series model—the forecast may include probabilistic percentile predictions (e.g., 50th, 90th). The forecast output reflects both macro-level seasonal cycles and micro-level short-term fluctuations, providing a continuous temporal projection that can be aligned to autoscaling control intervals. In some embodiments, forecasts are generated every 30 minutes and stored in a time-series database, supporting downstream modules that consume the forecast to formulate autoscaling decisions.

The automation system 110 determines 1460, based on the compute resource demand forecast, a time-based scaling recommendation, that specifies at least one of (i) vertical autoscaling parameters including per-container resource request values, or (ii) horizontal autoscaling parameters including replica count targets. For workloads operating with both VPA and HPA, the system may generate coordinated recommendations that prioritize horizontal scaling up to configured limits, after which vertical scaling is applied, or vice versa. The recommendation module may incorporate safety buffers, scaling bounds, and guardrails to prevent excessive churn or oscillation. It may also adjust parameters such as HPA target utilization thresholds and min/max replica limits dynamically, based on the volatility of the forecasted signal, thereby enabling both precision and adaptability in autoscaling behavior.

The automation system 110 provides 1470 the time-based scaling recommendation to a container orchestration system (e.g., Kubernetes system) for proactive resource provisioning. This orchestration system applies the recommendation by modifying deployment specifications, updating Horizontal Pod Autoscaler (HPA) or Vertical Pod Autoscaler (VPA) configuration objects, or triggering pod restarts when necessary to adjust container resource allocations. For vertical scaling, VPA components may consume the per-container request values and initiate in-place or restart-based updates to enforce the new resource configuration. For horizontal scaling, the orchestration system may adjust the number of pod replicas based on the recommended count and configured target utilization. These changes are applied in advance of anticipated demand shifts, enabling proactive provisioning. The autoscaling module may also monitor post-deployment performance and log scale events for feedback analysis. This feedback supports continuous refinement of forecast models, ensuring that future recommendations remain aligned with evolving workload characteristics and real-time system behavior.

### Example Computing System

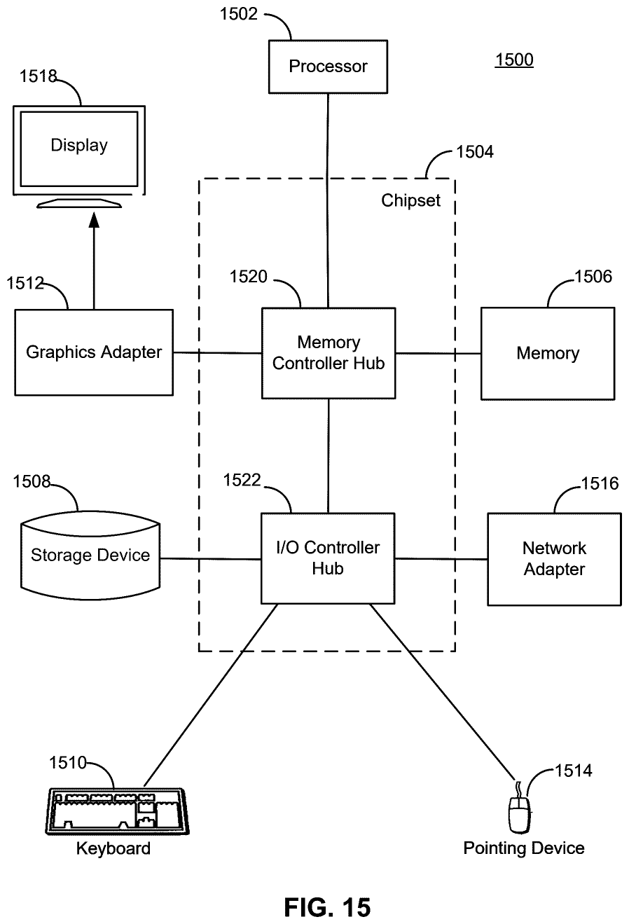

FIG. 15 is a block diagram of an example computer 1500 suitable for use in the networked computing environment 100 of FIG. 1. The computer 1500 is a computer system and is configured to perform specific functions as described herein. For example, the specific functions corresponding to automation system 110 may be configured through the computer 1500.

The example computer 1500 includes a processor system having one or more processors 1502 coupled to a chipset 1504. The chipset 1504 includes a memory controller hub 1520 and an input/output (I/O) controller hub 1522. A memory system having one or more memories 1506 and a graphics adapter 1512 are coupled to the memory controller hub 1520, and a display 1518 is coupled to the graphics adapter 1512. A storage device 1508, keyboard 1510, pointing device 1514, and network adapter 1516 are coupled to the I/O controller hub 1522. Other embodiments of the computer 1500 have different architectures.

In the embodiment shown in FIG. 15, the storage device 1508 is a non-transitory computer-readable storage medium such as a hard drive, compact disk read-only memory (CD-ROM), DVD, or a solid-state memory device. The memory 1506 holds instructions and data used by the processor 1502. The pointing device 1514 is a mouse, track ball, touchscreen, or other types of a pointing device and may be used in combination with the keyboard 1510 (which may be an on-screen keyboard) to input data into the computer 1500. The graphics adapter 1512 displays images and other information on the display 1518. The network adapter 1516 couples the computer 1500 to one or more computer networks, such as network 150.

The types of computers used by the entities and the automation system 110 of FIGS. 1 through 14 can vary depending upon the embodiment and the processing power required by the enterprise. For example, the automation system 110 might include multiple blade servers working together to provide the functionality described. Furthermore, the computers can lack some of the components described above, such as keyboards 1510, graphics adapters 1512, and displays 1518.

### Additional Considerations

The embodiments described herein provide a technical improvement over conventional autoscaling systems by introducing a predictive, seasonality-aware approach to compute resource provisioning in containerized environments. Traditional reactive autoscalers adjust resource allocations only after utilization metrics exceed predefined thresholds, leading to delayed response, under-provisioning during usage spikes, and inefficient over-provisioning during idle periods. In contrast, the embodiments described herein apply frequency-domain analysis—such as Fast Fourier Transform (FFT)—to detect recurring patterns in historical workload usage data and generate forward-looking forecasts that anticipate future demand. These predictions are used to produce time-based scaling recommendations that proactively adjust vertical and/or horizontal autoscaling parameters before demand inflection points occur. By aligning resource allocations with the periodic structure of workload behavior, the system reduces response latency, minimizes scaling oscillations, and improves both performance stability and infrastructure efficiency. The integration of multiple prediction strategies-selected based on the strength and complexity of seasonality-further enhances adaptability across diverse workload profiles, resulting in a more intelligent and responsive autoscaling framework.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcodes, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and is modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method, comprising:
determining whether a workload exhibits seasonality based on historical resource usage data;
in response to a positive determination, determining one or more principal frequency components that characterize the seasonality;
selecting a prediction approach from a plurality of prediction methods based on the principal frequency components;
generating a compute-resource-demand forecast at future time intervals using the selected prediction approach;
determining, from the compute-resource-demand forecast, a time-based scaling recommendation that specifies at least one of (i) vertical-autoscaling parameters comprising per-container resource-request values and (ii) horizontal-autoscaling parameters comprising replica-count targets; and
providing the time-based scaling recommendation to a container-orchestration system for proactive resource provisioning.

2. The method of claim 1, wherein the plurality of prediction methods comprise:
a next-window prediction method that determines a maximum resource value within a fixed future time window;
a single-period-aware prediction approach based on a single dominant frequency component; and
a multi-period-aware prediction approach based on multiple frequency components.

3. The method of claim 1, wherein determining the time-based scaling recommendation comprises:
determining both vertical autoscaling parameters and horizontal autoscaling parameters; and
applying coordination rules that define conditions for transitioning between vertical and horizontal scaling, wherein the coordination rules specify to prioritize horizontal scaling until reaching a maximum replica count, then applying vertical scaling.

4. The method of claim 1, wherein generating the compute resource demand forecast comprises applying an inverse Fourier transform to the one or more frequency components to reconstruct a predicted time series.

5. The method of claim 1, wherein generating the compute resource demand forecast comprises using a transformer-based machine learning model to produce predictions at multiple statistical percentiles of expected resource usage.

6. The method of claim 5, wherein the transformer-based machine learning model generates percentile-based forecasts, with lower percentile values applied to lower-priority workloads and higher percentile values applied to higher-priority workloads to accommodate usage variability.

7. The method of claim 1, wherein the time-based scaling recommendation specifies dynamic replica count boundaries that are adjusted over time based on the forecasted resource demand, including:
lowering minimum replica counts that are reduced during predicted low-demand periods; and
raising maximum replica counts that are increased during predicted high-demand periods.

8. The method of claim 1, further comprising:
monitoring actual resource consumption following implementation of the time-based scaling recommendation;
determining performance metrics including at least one of under-provisioning percentage, over-provisioning percentage, or symmetric mean absolute percentage error (sMAPE); and
modifying parameters of the selected prediction method based on the determined performance metrics.

9. The method of claim 1, wherein determining whether the workload exhibits seasonality comprises:
determining an energy ratio representing a proportion of total signal energy attributable to dominant frequency components; and
in response to determining that the energy ratio exceeds a predetermined threshold, classifying the workload as seasonal.

10. The method of claim 1, wherein the time-based scaling recommendation specifies:
preemptive scaling actions scheduled prior to predicted demand changes; and
timing offsets that align resource provisioning with phase transitions associated with the frequency components of the seasonality.

11. A non-transitory computer readable storage medium having instructions encoded thereon that, when executed by one or more processors, cause the one or more processors to perform steps comprising:
determining whether a workload exhibits seasonality based on historical resource usage data;
in response to a positive determination, determining one or more principal frequency components that characterize the seasonality;
selecting a prediction approach from a plurality of prediction methods based on the principal frequency components;
generating a compute-resource-demand forecast at future time intervals using the selected prediction approach;
determining, from the compute-resource-demand forecast, a time-based scaling recommendation that specifies at least one of (i) vertical-autoscaling parameters comprising per-container resource-request values and (ii) horizontal-autoscaling parameters comprising replica-count targets; and
providing the time-based scaling recommendation to a container-orchestration system for proactive resource provisioning.

12. The non-transitory computer readable storage medium of claim 11, wherein the plurality of prediction methods comprise:
a next-window prediction method that determines a maximum resource value within a fixed future time window;
a single-period-aware prediction approach based on a single dominant frequency component; and
a multi-period-aware prediction approach based on multiple frequency components.

13. The non-transitory computer readable storage medium of claim 11, wherein determining the time-based scaling recommendation comprises:
determining both vertical autoscaling parameters and horizontal autoscaling parameters; and
applying coordination rules that define conditions for transitioning between vertical and horizontal scaling, wherein the coordination rules specify to prioritize horizontal scaling until reaching a maximum replica count, then applying vertical scaling.

14. The non-transitory computer readable storage medium of claim 11, wherein generating the compute resource demand forecast comprises applying an inverse Fourier transform to the one or more frequency components to reconstruct a predicted time series.

15. The non-transitory computer readable storage medium of claim 11, wherein generating the compute resource demand forecast comprises using a transformer-based machine learning model to produce predictions at multiple statistical percentiles of expected resource usage.

16. The non-transitory computer readable storage medium of claim 15, wherein the transformer-based machine learning model generates percentile-based forecasts, with lower percentile values applied to lower-priority workloads and higher percentile values applied to higher-priority workloads to accommodate usage variability.

17. The non-transitory computer readable storage medium of claim 11, wherein the time-based scaling recommendation specifies dynamic replica count boundaries that are adjusted over time based on the forecasted resource demand, including:
lowering minimum replica counts that are reduced during predicted low-demand periods; and
raising maximum replica counts that are increased during predicted high-demand periods.

18. The non-transitory computer readable storage medium of claim 11, the steps further comprising:
monitoring actual resource consumption following implementation of the time-based scaling recommendation;
determining performance metrics including at least one of under-provisioning percentage, over-provisioning percentage, or symmetric mean absolute percentage error (sMAPE); and
modifying parameters of the selected prediction method based on the determined performance metrics.

19. The non-transitory computer readable storage medium of claim 11, wherein determining whether the workload exhibits seasonality comprises:
determining an energy ratio representing a proportion of total signal energy attributable to dominant frequency components; and
in response to determining that the energy ratio exceeds a predetermined threshold, classifying the workload as seasonal.

20. A system, comprising:
one or more processors; and
a non-transitory computer readable storage medium having instructions encoded thereon that, when executed by the one or more processors, cause the one or more processors to perform steps comprising:
determining whether a workload exhibits seasonality based on historical resource usage data;
in response to a positive determination, determining one or more principal frequency components that characterize the seasonality;
selecting a prediction approach from a plurality of prediction methods based on the principal frequency components;
generating a compute-resource-demand forecast at future time intervals using the selected prediction approach;
determining, from the compute-resource-demand forecast, a time-based scaling recommendation that specifies at least one of (i) vertical-autoscaling parameters comprising per-container resource-request values and (ii) horizontal-autoscaling parameters comprising replica-count targets; and
providing the time-based scaling recommendation to a container-orchestration system for proactive resource provisioning.
